(19) United States
(12) Patent Application Publication
(10) Pub. No.: US 2014/0371496 A1
(43) Pub. Date: Dec. 18, 2014

(54) SOLVENT-ENHANCED BIOMASS LIQUEFACTION

(71) Applicants: James Floyd STEVENS, JR., Paige, TX (US); Michelle K. YOUNG, Manvel, TX (US); Daniel D. EUHUS, Corvallis, OR (US); Alexander Bruce COULTHARD, Sugarland, TX (US); Douglas G. NAAE, Sugarland, TX (US); Kerry Kennedy SPILKER, Houston, TX (US); Jason Christopher HICKS, Notre Dame, IN (US); Subhasis BHATTACHARYA, Walnut Creek, CA (US); Paul M. SPINDLER, Katy, TX (US)

(72) Inventors: James Floyd STEVENS, JR., Paige, TX (US); Michelle K. YOUNG, Manvel, TX (US); Daniel D. EUHUS, Corvallis, OR (US); Alexander Bruce COULTHARD, Sugarland, TX (US); Douglas G. NAAE, Sugarland, TX (US); Kerry Kennedy SPILKER, Houston, TX (US); Jason Christopher HICKS, Notre Dame, IN (US); Subhasis BHATTACHARYA, Walnut Creek, CA (US); Paul M. SPINDLER, Katy, TX (US)

(73) Assignee: CHEVRON U.S.A. INC., San Ramon, CA (US)

(21) Appl. No.: 14/476,834

(22) Filed: Sep. 4, 2014

Related U.S. Application Data
(63) Continuation of application No. 13/079,777, filed on Apr. 4, 2011, now abandoned.
(60) Provisional application No. 61/362,243, filed on Jul. 7, 2010.
(60) Provisional application No. 61/412,332, filed on Nov. 10, 2010.

(51) Int. Cl. C10G 1/04; B01D 11/02

(52) U.S. Cl. CPC C10G 1/042; B01D 11/0292
USPC 585/240; 422/187; 422/242; 252/183.11

(57) ABSTRACT

The present invention provides an improved method for solvent liquefaction of biomass to produce liquid products such as transportation fuel. The method uses a novel solvent combination that promotes liquefaction relatively quickly, and it reduces the need to transport large amounts of hydrogen or hydrogen-carrying solvents. It operates at lower pressure than previous methods, does not require a catalyst or hydrogen gas or CO input, and provides very high conversion of biomass into a bio-oil that can be further processed in a petroleum refinery. It also beneficially provides a way to recycle a portion of the crude liquefaction product for use as part of the solvent combination for the biomass liquefaction reaction.

### RELATED APPLICATIONS

This is a continuation of U.S. patent application Ser. No. 13/079,777 filed Apr. 4, 2011 and claims priority to U.S. Provisional Applications 61/362,243, filed Jul. 7, 2010, and 61/412,332, filed Nov. 10, 2010.

### TECHNICAL FIELD

The present disclosure relates generally to methods for producing a liquefied product suitable for hydroprocessing from biomass, wherein the biomass typically includes both lignin and cellulosic material. The liquified product is produced by solvent-enhanced liquefaction that can occur without use of a catalyst. The product is a bio-oil that is easily transported and further processed into fuel or feedstocks, including a ‘drop-in’ transportation fuel fully compatible with existing vehicle engines and transportation fuel infrastructure. The process also generates gaseous and solid by-products, which can also be utilized. The process provides higher efficiency of biomass conversion than methods in the prior art, and produces less solid by-product (referred to as ‘char’). The process does not require hydrogen or carbon monoxide and thus minimizes the need to transport or produce hydrogen or donor solvents at the site where liquefaction is done. This makes it easier to perform liquefaction at a local site such as a wood pulp generating facility, without the need to have full hydroprocessing systems available.

### BACKGROUND ART

Biomass offers a potentially renewable source for fuel and other organic feedstock as a supplement or replacement for products currently obtained from limited supplies of petroleum, coal, and natural gas. Biomass typically comprises large amounts of cellulose, which can be bound together by lignin. Lignin and cellulose are more highly oxidized than petroleum products, and contain high proportions of oxygen. It is desirable to lower the oxygen content of the lignin and cellulose, because this increases their energy content for use as combustible fuels such as a transportation fuel; but because lignin and cellulose have radically different chemical structures, they often need to be processed separately, using very different conditions. Moreover, prior art methods for initially processing biomass did not generally reduce oxygen content sufficiently to produce a bio-oil that could be co-processed with conventional petroleum processing methods and streams.

Many processes are known for converting biomass into liquid fuels. These include pyrolysis followed by hydroprocessing, saccharification followed by fermentation, gasification followed by Fischer-Tropsch synthesis, and donor solvent liquefaction followed by hydroprocessing. The present invention relates to improved methods for solvent-enhanced liquefaction in preparation for hydroprocessing and production of liquid fuels.

Early efforts to provide commercially viable methods to convert lignin-containing biomass into a liquid fuel or feedstock utilized hydrogenation with hydrogen gas at high temperatures. U.S. Pat. No. 3,223,698. The methods in the '698 patent described improved catalysts, but still required hydrogen gas and one or more essential catalysts such as an iron sulfide. Conversion efficiency was low, and energy inputs for heating the conversion reaction and providing hydrogen gas were high.

More recent methods use base-catalyzed and/or superacid catalyzed processes: these methods retain substantial oxygen content in the product, and also require more processing steps. U.S. Pat. No. 6,172,272. Other processes use an aqueous treatment of biomass to produce a slurry having at least some of the biomass solids degraded into a suspension that is suitable for further processing. U.S. Pat. No. 7,262,331. However, these methods do not produce a liquefied product that can be co-processed by conventional liquid handling machinery and methods such as by being blended into a petroleum refinery stream.

Methods for converting cellulose into fuel often involve fermentation to produce ethanol from readily-utilized carbohydrates; this tends to require large reaction volumes and lots of energy to separate the product (e.g., ethanol) from the complex product of the fermentation reactions. They also work best with relatively high quality carbohydrates that are low in lignin, thus they are most efficient when using agricultural products that are usually grown in ways that displace or compete with food production. Other references that describe related technology include U.S. Pat. Nos. 6,207,808; 6,139,723; 6,100,385; 6,043,392; 5,959,167; 5,735,916; 5,400,726; 5,336,819; 5,256,278; 5,120,429; 4,982,027; 4,935,567; 4,795,841; 4,670,613; 4,647,704; 4,604,183; 4,493,761; 4,485,008; 4,420,644; 4,409,089; 4,338,199; 4,247,384; 4,155,832; 4,052,292; and 4,133,646.

The current invention relates to a solvent-enhanced liquefaction process useful for processing biomass. Conventional solvent liquefaction processes involve combining biomass with a hydrogen donor solvent (e.g. tetralin) that can deliver hydrogen to reduce the oxidation level and oxygen content of the biomass materials. Reducing the oxidation level increases the energy density of the product, making it more suitable for use as a fuel by combustion or similar methods. The mixture of biomass and hydrogen donor solvent is then heated under pressure to promote liquefaction of at least part of the solid biomass. This involves many different chemical reactions, and typically requires a catalyst to promote the desired reactions; most such methods also require either hydrogen gas or carbon monoxide as additional inputs. These processes are generally conducted at 300° C. to 420° C. and at pressures of 1500-3000 psi. The product of such processes is sometimes referred to as ‘green crude’, which is a generic term for partially processed plant-derived liquid products that are still relatively highly oxygenated and typically must undergo hydroprocessing and various other modification and/or separation processes before becoming a useful liquid fuel product.

One of the complicating factors for conversion of crude biomass into a transportation fuel or other useful liquid product is the heterogeneity of the starting materials. Some processes are designed to be particularly efficacious when using lignin as a feedstock, and others primarily use cellulose materials. A need remains for efficient processes that handle both materials in one process and efficiently produce liquid fuel or feedstock products.

Another limitation of the prior art liquefaction methods is the need to place pre-treatment and hydroprocessing facilities together. A pretreatment to reduce oxygen content is generally necessary to prepare raw biomass for hydroprocessing, and it is preferable to convert solid biomass into liquid form at this early stage to simplify handling and transportation. However, conventional pretreatment processes require large amounts of a hydrogen donor solvent or hydrogen gas. As a result, hydrogen gas or hydrogen donor solvent must be transported in large quantities to the pretreatment site; or hydrogen production facilities must be provided at the pretreatment site. Either option raises costs and undermines the environmental objectives served by using biomass to produce fuel. Using conventional methods for solvent liquefaction makes it difficult to locate the pretreatment process and facilities away from the hydroprocessing facility, which will have its own hydrogen source or production.

Prior art methods for solvent liquefaction of biomass thus suffer from high capital costs and/or compromised efficiency associated with the pretreatment methods, and often also provide low yields of desirable products, or product quality that does not meet current transportation fuel needs. For example, when using conventional methods, the ‘green crude’ product from biomass is often not miscible with fossil fuel-derived hydroprocessing streams in conventional refineries. As a result, the green crude from such processes generally cannot be blended into a conventional petroleum-based refinery stream for hydroprocessing.

The present invention addresses deficiencies of the prior art methods, and provides an improved method for solvent-enhanced liquefaction of biomass to produce an easily transported liquid product for further processing, as well as systems for implementation of the improved methods that minimize some of the problems encountered with earlier methods.

### DISCLOSURE OF THE INVENTION

The invention provides methods and systems for converting biomass solids into a liquid product by solvent-enhanced liquefaction. The methods use a solvent combination that promotes liquefaction under suitable pressure and temperature conditions. The solvent combination includes a mixture of solvents including at least one make-up solvent and a liquefaction solvent with specific characteristics and functions. The solvent combination provides suitable solubilization of components of the biomass to promote liquefaction, and helps in minimizing side reactions. The solvent combination also provides miscibility of the bio-oil product with hydrocarbon or petroleum refinery streams, permitting the product to be co-processed in a petroleum refinery. The improved methods reduce the need for hydrogen gas or hydrogen donor solvent in the liquefaction process, thereby making it possible to site the liquefaction facility near a biomass source. Multiple liquefaction sites can supply a central hydroprocessing facility (e.g., refinery), rather than making it practically essential to locate hydroprocessing and liquefaction facilities together. The improved methods also greatly reduce the need to import hydrogen or hydrogenated products to the liquefaction site. Moreover, the methods reduce the need for catalysts and for high operating pressures, and thus contribute to a more economical and environmentally sensitive biofuel production process. Operation without a catalyst is another advantage that can be achieved to enable use of a flow-through system. It is well known that components of the bio-oil processing stream tend to foul the catalysts used in conventional catalytic liquefaction methods. Chevron has reported relatively rapid decline in catalytic activity for some of its proprietary catalysts, as indicated and measured by the increasing oxygen content of the product; FIG. 9 depicts data for this catalyst degradation. Thus, when the methods described herein are run without a catalyst, the methods greatly improve the process of making a consistent product with un-interrupted operation. Nevertheless, in some embodiments, it may be desirable to use catalysts to control or accelerate certain aspects of the liquefaction process, or to permit operation at lower temperature and/or pressure as compared to catalyst-free operation.

The present invention provides a method and a system for processing crude plant-derived biomass produces a liquid bio-oil product that can be further treated to produce a liquid fuel or feedstock, for example a transportation fuel. The method and system can optionally include additional processing steps such as hydroprocessing to produce a transportation fuel or similar liquid product. Methods and systems for converting oxygenated ‘green crude’ products such as this bio-oil product of the current invention into further processed products are known in the art. See e.g., U.S. Pat. Nos. 4,759,841 and 7,425,657.

The bio-oil produced by the methods described herein can be added to a conventional refinery stream for co-processing into a finished fuel product. Further processing of the bio-oil produced by the methods described herein can include hydroprocessing, and/or hydrodeoxygenation, and/or catalytic cracking. Further processing readily converts the bio-oil produced by the instant processes into a useful transportation fuel.

In one aspect, the invention provides a process for liquefaction of biomass, which comprises combining biomass with a solvent combination comprising a make-up solvent and at least one liquefaction solvent that promotes liquefaction. The radius of interaction quantifies how the polar, non-polar and hydrogen bonding properties of the solvent match those of a biocrude model compound, which can be for example coumaryl alcohol. The liquefaction solvent has a Hansen radius of interaction with coniferyl alcohol of less than 15 MPa^{1/2}, preferably less than 14 MPa^{1/2}. Coniferyl alcohol is also called 4-hydroxy-3-methoxy cinnamyl alcohol.

This mixture of solvents and biomass is held in a pressurizable container or region and heated to a temperature of at least about 250° C. to produce a crude reaction product comprising a liquid bio-oil product. The process optionally does not include hydrogen or carbon monoxide as an input, and may be done with or without a catalyst.

In some embodiments, no catalyst is used to promote the liquefaction reaction: the solvent combination and operating temperature and pressure provide efficient liquefaction, converting at least about 80%, preferably at least about 90% of the biomass solids (on a dry weight basis) into liquid and/or gaseous products. As a result of the solvent and condition selections described herein, high efficiency can be obtained without adding a catalyst, and use of conventional catalysts to promote the liquefaction process result in only slightly improved efficiency.

The crude liquid product contains residues of the organic solvents introduced to promote liquefaction, along with a mixture of materials derived from partial degradation of the biomass. The crude liquid product of the liquefaction process, when substantially separated from any residual solids, is referred to herein as a bio-oil, and is a ‘green crude’ similar to the ‘green crude’ products obtained by other biomass processing methods. The bio-oil made by the present methods includes a mixture of solvent residues from the hydrogen donor and additional solvents, as well as liquefied products derived from biomass. Unlike prior green crudes, the bio-oil made by the present methods can be introduced into a petroleum-based refinery stream for hydroprocessing to produce a bio-fuel.

In one aspect, the invention provides a process for liquefaction of biomass, which comprises combining biomass with a solvent combination comprising at least one liquefaction solvent and at least one make-up solvent in a pressurized reaction container to form a mixture, and heating the mixture to a temperature of at least about 250° C. under pressure of at least about 200 psi to produce a crude reaction product comprising a liquid bio-oil product; the liquefaction solvent has a Hansen radius of interaction with coniferyl alcohol of less than 15 MPa^{1/2}, and the process does not include hydroprocessing. This liquefaction solvent contributes to rapid and efficient liquefaction with reduced char formation.

In some embodiments, the biomass comprises lignin and/or cellulose. Typically it comprises at least about 10% lignin.

In some embodiments, the solvent combination comprises a phenol or an anisole. Suitable phenols and anisoles are described herein, as well as suitable amounts. The phenol or anisole may be provided as an added material, or it may be present in a reactor stream such as a recycle stream used as part of the solvent combination. In some embodiments, the solvent combination comprises sinapyl alcohol, p-coumaryl alcohol, phenol, 2,6-dimethoxyphenol, 3,5-dimethyl phenol, 2,4-dimethyl phenol, anisole, 2-methyl anisole, 3-methyl anisole, 4-methyl anisole, guaiacol, m-cresol, o-cresol, p-cresol, phenoxypropanol, 1-butanol, tetrahydrofuran, naphthalene, acetone, 1-methylnaphthalene, tetralin, or a green crude or a fraction thereof.

Preferably, the liquefaction solvent has a Hansen radius of interaction with coniferyl alcohol less than 14 MPa^{1/2}. For example, the liquefaction solvent may have a Hansen radius of interaction with coniferyl alcohol between 5 and 14 MPa^{1/2}. This provides a solvent that promotes solubilization of the biomass and of the products to enhance reaction rate and reduce char formation. In some embodiments, the liquefaction solvent comprises one or more phenolic compounds, aromatic alcohols, or anisoles.

Typically, the process involves heating the mixture in a pressurized container to a temperature between about 300° C. and 600° C. for a period of time up to about 120 minutes. The container can be a typical reaction vessel, or it can be a pipe or set of pipes or similar tube-like enclosures configured for flow-through operation.

In typical embodiments, the pressure in the pressurized container is between about 200 psi and about 1500 psi while the mixture is being heated. Preferably it is about 300-600 psi.

In some embodiments, the reaction is achieved when the mixture in the pressurized container is heated to a temperature between about 350° C. and 420° C. while the pressure is between about 200 psi and about 800 psi.

The process described herein can be performed with little or no added hydrogen donor solvent; in other embodiments, at least some hydrogen donor solvent is used. In some embodiments, the solvent combination comprises up to about 25% hydrogen donor solvent.

The make-up solvent enhances liquefaction and also promotes blending of the bio-oil product made by the processes herein with a petroleum processing stream. In some embodiments, the make-up solvent comprises a refinery stream produced from a petroleum input. In some embodiments, the amount of make-up solvent used is between 5% and 25% of the amount of biomass on a dry weight basis.

Frequently, the make-up solvent can be modified under the liquefaction conditions. In some embodiments, the make-up solvent is converted into a make-up solvent product under the liquefaction conditions, and the make-up solvent product is suitable for hydroprocessing with the bio-oil product derived from the biomass liquefaction. Additionally, in part based on the properties of the make-up solvent, the bio-oil product can be combined with a refinery stream for co-processing to provide a transportation fuel. The make-up solvent can be provided by a refinery stream from a petroleum refinery. In some such embodiments, the refinery stream is a light cycle oil having a boiling range below about 343° C.

In some of the foregoing embodiments, a portion of the crude reaction product is diverted to form a solvent recycle stream, which is used as part of the solvent combination for use in the process as described above. In some such embodiments, the portion of the crude reaction product that is recycled has a boiling range between about 180° C. and 343° C.

In some of the foregoing embodiments, no metal reagent or metal catalyst is used to promote liquefaction. In other embodiments, a metal reagent or a metal catalyst may be added to the reaction mixture to promote liquefaction.

In addition to the liquefaction reaction, in another aspect the invention provides a method to modify the bio-oil from the reactions described herein to provide a drop-in transportation fuel blendstock or other value-added processed liquid product. In some embodiments, this involves hydroprocessing the bio-oil product and/or feeding the bio-oil product to a catalytic cracker.

In some embodiments of the reactions described above, the method further involves adding a processing solvent to the liquefaction mixture or to the crude liquefaction reaction product. The processing solvent is often added after the liquefaction reaction has proceeded close to completion, and can be used to promote flow processing steps such as filtration to remove solids. In some embodiments, the processing solvent is a C3-C6 ketone solvent and is added after completion of the liquefaction reaction. In preferred embodiments, the processing solvent is acetone.

The novel methods described herein can be utilized without any added hydrogen gas or carbon monoxide (CO). However, it is sometimes advantageous to add small amounts of hydrogen. As such, in some embodiments, hydrogen gas is added. Typically, no more than about 0.5% hydrogen gas is added, measured on a weight-to-weight (wt/wt) basis relative to the amount of biomass used. In some embodiments, less than about 0.25% hydrogen is added. In preferred embodiments, no hydrogen gas is added.

Similarly, the methods may be used with no added CO. However, in some embodiments, small amounts of CO may be introduced, e.g., up to about 0.5% by wt relative to the biomass. Typically, CO is not introduced unless CO is part of a volatile stream recaptured from the liquefaction process as described herein, in which case overall efficiency of the process may be increased if the recaptured volatile fraction, potentially containing CO, is recycled as an additive to the liquefaction process. Otherwise, typically CO is not used for the liquefaction process, or only up to about 0.5% on a wt/wt basis relative to the amount of biomass is used.

Furthermore, the methods may be used without the addition of metal reagents or metal catalysts. However, a metal reagent or a metal catalyst may be used to enhance the liquefaction process. For example, a metal reagent may be used to remove oxygen from the bio-oil product, or a metal catalyst may be used to reduce the molecular weight of the bio-oil product. The metal reagent and metal catalyst may be used separately or together.

In one embodiment of the methods, the solvent liquefaction step may involve adding a metal reagent. The metal reagent may include one or more Group VIII metals, Group IB metals, Group IIB metals, Group IIIA metals, Group IVA metals, or a combination of metals from these groups. In some variations of the methods, the metal reagent may include one or more Group VIII metals. In other variations, the metal reagent may include one or more Group IB metals. In other variations, the metal reagent may include one or more Group IIB metals. In yet other variations, the metal reagent may include one or more Group IIIA metals. In yet other variations, the metal reagent may include one or more Group IVA metals. In some variations of the methods, the metal reagent may include iron (Fe), cobalt (Co), nickel (Ni), ruthenium (Ru), rhodium (Rh), palladium (Pd), osmium (Os), iridium (Ir), platinum (Pt), chromium (Cr), molybdenum (Mo), copper (Cu), silver (Ag), gold (Au), zinc (Zn), cadmium (Cd), mercury (Hg), scandium (Sc), yttrium (Y), lanthanum (La), titanium (Ti), zirconium, (Zr), hafnium (Hf), thorium (Th), or a combination of these metals. In other variations, the metal reagent may include iron (Fe), platinum (Pt), nickel (Ni), or a combination of these metals. In yet other variations, the metal reagent may include iron (Fe) or nickel (Ni). In yet other variations, the metal reagent may include iron (Fe). In yet other variations, the metal reagent may include molybdenum (Mo).

In one embodiment of the methods, the solvent liquefaction step may involve adding a metal catalyst. The metal catalyst may include one or more Group VIII metals, Group IB metals, Group IIB metals, Group IIIA metals, Group IVA metals, or a combination of metals from these groups. In some variations of the methods, the metal catalyst may include one or more Group VIII metals. In other variations, the metal catalyst may include one or more Group IB metals. In other variations, the metal catalyst may include one or more Group IIB metals. In yet other variations, the metal catalyst may include one or more Group IIIA metals. In yet other variations, the metal catalyst may include one or more Group IVA metals. In some variations of the methods, the metal catalyst may include iron (Fe), cobalt (Co), nickel (Ni), ruthenium (Ru), rhodium (Rh), palladium (Pd), osmium (Os), iridium (Ir), platinum (Pt), chromium (Cr), molybdenum (Mo), copper (Cu), silver (Ag), gold (Au), zinc (Zn), cadmium (Cd), mercury (Hg), scandium (Sc), yttrium (Y), lanthanum (La), titanium (Ti), zirconium, (Zr), hafnium (Hf), thorium (Th), or a combination of these metals. In other variations, the metal catalyst may include iron (Fe), platinum (Pt), nickel (Ni), or a combination of these metals. In yet other variations, the metal catalyst may include iron (Fe) or nickel (Ni). In yet other variations, the metal catalyst may include iron (Fe). In yet other variations, the metal catalyst may include molybdenum (Mo). In yet other embodiments, the metal catalyst may be a zeolite or a molybdenum salt. The molybdenum salt may include any organic molybdenum salts that form finely dispersed molybdenum sulfide under the method conditions described herein, such as Molyvan A.

The metal reagent or the metal catalyst may be included in any portion of the reaction container where the biomass-solvent combination mixture will contact the metal reagent or the metal catalyst while it is heated to a temperature of at least about 250° C. under pressure of at least about 200 psi. In some variations of the methods, biomass-solvent combination mixture will contact the metal reagent or the metal catalyst while it is heated at a temperature between 325° C. and 455° C. In other variations, the temperature is between 350° C. and 420° C. In other variations, the pressure is between 200 psi and 1500 psi. In yet other variations, the pressure is between 200 psi and 800 psi.

The process described above, optionally excluding an optional additional hydroprocessing step, can be operated as a continuous flow process wherein the solvent mixture and biomass pass through a reaction container configured for flow-through operation, where they are heated under pressure for a sufficient time to promote liquefaction. Suitable heating times and pressures are as described above.

In another aspect, the invention provides a system for liquefaction of biomass, comprising:

a reaction container suitable for conducting a biomass liquefaction process at a temperature above about 300° C. and a pressure above about 300 psi;

wherein the reaction container contains:
a solvent combination comprising a make-up solvent, and at least one liquefaction solvent having a Hansen radius of interaction with coniferyl alcohol of less than 15 MPa^{1/2},
and biomass comprising lignin and/or cellulose.

This system can be configured as a batch processing system or as a continuous flow system, and can be configured to implement any of the processes described herein.

In some embodiments of this system, the mass of the solvent combination in the reaction container is about 50% or more of the mass of biomass in the reaction container. In some embodiments, the system is configured for flow-through operation, and the reaction container is a flow-through container and the system is configured to provide a continuous flow process for any of the processes described herein. In some embodiments, the system also comprises a recycle subsystem that is configured to separate a portion of the crude product from the reaction container to form a recycle solvent stream, and to deliver the recycle solvent stream to the reaction container. The recycle solvent stream can provide at least part of the solvent mixture, such as the liquefaction solvent; it can comprise one or more phenols or anisoles.

In some embodiments of the system, the mass of the make-up solvent comprises about 25% or less of the mass of the biomass in the reaction container when the reaction container is ready for operation.

In some implementation, the system uses a solvent combination that contains a light cycle oil from a refinery; this solvent can be the make-up solvent or a portion thereof. It may be partially hydroprocessed before use to provide some hydrogen donor solvent capacity if desired.

The reaction container may further contain a metal reagent or a metal catalyst used to enhance the liquefaction process. The metal reagent and metal catalyst may be used separately or together.

In one embodiment of the system, the metal reagent may include one or more Group VIII metals, Group IB metals, Group IIB metals, Group IIIA metals, Group IVA metals, or a combination of metals from these groups. In some variations of the system, the metal reagent may include one or more Group VIII metals. In other variations, the metal reagent may include one or more Group IB metals. In other variations, the metal reagent may include one or more Group IIB metals. In yet other variations, the metal reagent may include one or more Group IIIA metals. In yet other variations, the metal reagent may include one or more Group IVA metals. In some variations, the metal reagent may include iron (Fe), cobalt (Co), nickel (Ni), ruthenium (Ru), rhodium (Rh), palladium (Pd), osmium (Os), iridium (Ir), platinum (Pt), chromium (Cr), molybdenum (Mo), copper (Cu), silver (Ag), gold (Au), zinc (Zn), cadmium (Cd), mercury (Hg), scandium (Sc), yttrium (Y), lanthanum (La), titanium (Ti), zirconium, (Zr), hafnium (Hf), thorium (Th), or a combination of these metals. In yet other variations, the metal reagent may include iron (Fe), platinum (Pt), nickel (Ni), or a combination of these metals. In yet other variations, the metal reagent may include iron (Fe) or nickel (Ni). In yet other variations, the metal reagent may include iron (Fe). In yet other variations, the metal reagent may include molybdenum (Mo).

In another embodiment of the system, the metal catalyst may include one or more Group VIII metals, Group IB metals, Group IIB metals, Group IIIA metals, Group IVA metals, or a combination of metals from these groups. In some variations of the system, the metal catalyst may include one or more Group VIII metals. In other variations, the metal catalyst may include one or more Group IB metals. In other variations, the metal catalyst may include one or more Group IIB metals. In yet other variations, the metal catalyst may include one or more Group IIIA metals. In yet other variations, the metal catalyst may include one or more Group IVA metals. In some variations, the metal catalyst may include iron (Fe), cobalt (Co), nickel (Ni), ruthenium (Ru), rhodium (Rh), palladium (Pd), osmium (Os), iridium (Ir), platinum (Pt), chromium (Cr), molybdenum (Mo), copper (Cu), silver (Ag), gold (Au), zinc (Zn), cadmium (Cd), mercury (Hg), scandium (Sc), yttrium (Y), lanthanum (La), titanium (Ti), zirconium, (Zr), hafnium (Hf), thorium (Th), or a combination of these metals. In yet other variations, the metal catalyst may include iron (Fe), platinum (Pt), nickel (Ni), or a combination of these metals. In yet other variations, the metal catalyst may include iron (Fe) or nickel (Ni). In yet other variations, the metal catalyst may include iron (Fe). In yet other variations, the metal catalyst may include molybdenum (Mo). In yet another embodiment of the system, the metal catalyst is a zeolite or a molybdenum salt, such as Molyvan A.

In some embodiments, the system described herein also includes one or more subsystems for feeding biomass and/or solvents into the reaction container; for heating the reaction container; for capturing effluent gases such as CO₂ produced by the reaction; or for removing char (insoluble material) from the reaction mixture. In some embodiments, the system includes a filtration system to remove residual solids from the crude reaction product or bio-oil produced in the reaction container.

In some embodiments, the system further comprises a heater that is fueled at least in part by gases produced in the liquefaction reaction and/or by residual solids captured by the filtration system, and which is configured to heat the reaction container.

In another aspect, the invention provides a novel composition comprising:
i. biomass,
ii. a recycle stream from a biomass liquefaction reaction,
iii. and a make-up solvent.

In some embodiments, this composition includes a make-up solvent that comprises a refinery light cycle oil. Optionally, the recycle stream comprises solvents having a Hansen radius of interaction with coniferyl alcohol between about 9 MPa^{1/2} and about 14 MPa^{1/2}. In some embodiments, the solvent combination used in this composition has a Hansen radius of interaction with coniferyl alcohol of about 9 MPa^{1/2} and about 14 MPa^{1/2}.

In many of the foregoing embodiments, the biomass comprises cellulose and lignin, typically at least about 10% lignin by weight. Typically, the biomass used has a moisture content of at least about 15%.

In another aspect, the invention provides a bio-oil produced by any of the processes described above. In some embodiments, the bio-oil is further processed to provide a transportation fuel.

In some of the methods described herein, no added hydrogen gas or hydrogen donor solvent is used.

In some embodiments of the processes described herein, gaseous CO produced during the liquefaction reaction is captured and is injected into a liquefaction mixture to promote deoxygenation: CO can be used in place of hydrogen gas to promote deoxygenation in these reactions. In other embodiments, no added CO is used to promote the process.

In some embodiments of the processes described herein, less than 10% of the biomass is converted to char.

In some embodiments, the biomass used in the methods and compositions described herein has a moisture content of at least about 15%.

In some embodiments, the product from the above process comprises a bio-oil that is suitable for hydroprocessing to produce a value-added product such as a transportation fuel. In some embodiments, the process thus further includes subsequent processing steps such as hydroprocessing a bio-oil product made by the methods described herein and/or feeding the bio-oil product to a catalytic cracker.

In addition to the liquid products from this reaction, solid by-products referred to as char, and gaseous by-products are produced in small amounts. While these are generally not major products of the process, they can be valuable as well; in some embodiments, the solid and/or gaseous byproducts from the process are captured and used or recycled.

The current process produces less char than prior art processes. While the prior art typically results in over 10% char production on a dry-weight basis, the current methods produce typically about 7% or less, often between 3% and 7%. This char can be a useful by-product, too. For example, char from the process can be burned to produce heat to drive the liquefaction process described herein.

Gaseous by-products of the process include substantial amounts of carbon monoxide (CO), which can be captured and blended with the mixture of inputs into the liquefaction reaction, where the CO can contribute to deoxygenation of the biomass, for example, by combining with water produced in the process to produce hydrogen via the Water Gas Shift reaction, or by scavenging oxygen from the system to produce CO₂ as a by-product. Each of these processes contributes to reducing the oxygen content of the biomass, without a need for using hydrogen or a hydrogen donor solvent.

The liquefaction process, or subsequent processing of the bio-oil product obtained from it, may also be enhanced by adding a processing solvent to the liquefaction mixture or to the crude liquefaction reaction product. The processing solvent is a low-boiling polar organic compound, such as acetone, and its presence reduces formation of insoluble by-products and increases the overall yield of bio-oil.

In another aspect, the invention provides a system for liquefaction of biomass that is designed to perform the process described above. The system comprises a reaction container suitable for conducting a biomass liquefaction process at a temperature above about 300° C. and a pressure above about 200 psi (typically above 300 psi, and up to at least about 600 psi or up to about 800-1000 psi). The reaction container can be a vessel, like a conventional reaction chamber or pot where a batch process is conducted, or it can be a pipe or similar enclosed conduit as part of a flow-through system where the process described herein can operate as a continuous-flow process. Preferably, the reaction container comprises one or more pipes or tubes for performing the process as a flow-through process such as a continuous flow system.

The reaction container is configured to contain a solvent combination comprising a make-up solvent and at least one liquefaction solvent having a Hansen radius of interaction with coniferyl alcohol of less than 15 MPa^{1/2}, and biomass comprising lignin and/or cellulose. The system is configured to provide suitable operating pressures and temperatures for the process described herein. The system may be configured to process a batch of biomass at a time, or to operate as a continuous flow process.

In some embodiments, the reaction container contains biomass and a solvent combination, in amounts such that the mass of the solvent combination in the reaction container is about 50% or more of the mass of biomass in the reaction container. The solvent combination is as described above, and contains a make-up solvent. Typically, the mass of the make-up solvent comprises about 25% or less of the mass of the biomass in the reaction container when the reaction container is ready for operation, and the make-up solvent can be provided by partially hydrogenated recycle stream from the process described herein or from a refinery stream. The solvent combination also comprises a liquefaction solvent, which can be a recycle stream from the process described herein. Optionally, the solvent combination comprises a light cycle oil from a refinery, which can serve as the make-up solvent.

Optionally, the system further comprises a recycle subsystem which is configured to separate a portion of the crude product from the liquefaction reaction to form a recycle solvent stream, and to deliver the recycle solvent stream to the reaction container. The system further may include one or more subsystems for feeding biomass and/or solvents into the reaction container, and/or a filtration system to remove residual solids from the crude reaction product or bio-oil produced in the reaction container, and/or a heater that is fueled at least in part by gases produced in the reaction container during biomass processing and/or by residual solids captured by the filtration system, and which is configured to heat the reaction container.

In another aspect, the invention provides a composition comprising:
i. biomass,
ii. a recycle stream from a biomass liquefaction reaction, and
iii. a make-up solvent.

The make-up solvent in this composition may comprise a refinery light cycle oil. The recycle stream in this composition may comprise a solvent or mixture of solvents having a Hansen radius of interaction with coniferyl alcohol between about 9 MPa^{1/2} and about 14 MPa^{1/2}. This solvent provides improved yield and reduced char formation, which translates into increased deoxygenation of the biocrude. A suitable solvent can be obtained by blending a recycled stream from the solvent liquefaction reaction, which is oxygenated, with a make-up solvent that can be a hydrocarbon stream from a refinery. The composition may comprise one or more phenolic compounds, aromatic alcohols, or anisoles. The biomass may have a moisture content of at least 15%, optionally at least about 25% or higher.

In another aspect, the invention provides a bio-oil product that is produced by the methods or systems described herein. Other features and aspects of the invention are described below. It is understood that the detailed description and examples herein are provided to exemplify the scope of the invention, not to limit it.

### BRIEF DESCRIPTION OF THE DRAWINGS

FIG. 1 illustrates the correlation of biomass conversion with the solvent parameter used herein (the Hansen radius of interaction with coniferyl alcohol, measured in units of MPa^{1/2}), where conversion is measured by amounts of acetone-insoluble material in the reaction product. Square symbols represent hydrocarbon (oxygen-free) solvent systems, while the diamond shapes represent various oxygenated solvents.

FIG. 2 is a bar graph showing acetone insolubles, gaseous products, and liquid products for several reaction mixtures, and illustrates that the presence of p-cresol results in decreased solids (acetone insoluble material that represents either unconverted biomass or polymerized by-products) and increased liquid products.

FIG. 3 is a graph of reaction product composition (solid, gas, liquid) to show how the product is affected by moisture content of the biomass used in the reaction.

FIG. 4 is a graph of product composition (solid, gas, liquid) as a function of heating time for reactions run at 390° C. FIG. 4 shows peak levels of liquid products and a minimum level of insoluble solids at reaction times between 10 and 25 minutes.

FIG. 5 is a schematic diagram depicting a system designed to use the methods described herein for biomass conversion to a bio-oil that can be converted into transportation fuel or other end products by known methods such as hydroprocessing.

FIG. 6 is a block diagram of a continuous flow system whose operation is described in the Examples. The points where mass balances were measured are depicted with lighter shading. Two additional features, vent line drop-out vessels Sep-4 and Sep-5, are not shown. R1 is a reaction container; the extruder provides a mechanism to introduce biomass solids into a pressurized reaction system; pumps are provided to inject solvents into the extruder and to introduce a processing solvent (acetone) to an output stream after the reaction has occurred. Sep-1 and Sep-2 represent separation subsystems. B1 and B2 represent the primary product fractions. T3, T4, T5 and T6 represent waste or byproduct streams.

FIG. 7 is a graph of the simulated distillation curves for the two main product outputs B1 and B2 in the system shown in FIG. 6.

FIG. 8 shows a schematic of a solvent liquefaction facility coupled with an existing refinery, where biomass (nominally 1″ size wood chips, for example, containing about 20% moisture content) is converted to a biocrude, which is then hydroprocessed to a drop-in fuel product.

FIG. 9 shows deactivation of some proprietary Chevron catalysts by a biocrude containing lignin or phenolics derived therefrom, as measured by increasing oxygen content of the crude product over time as the catalyst loses activity.

FIG. 10 presents the equations used to calculate mass balance of products from a liquefaction operation as described herein.

FIG. 11A is a GC trace comparing B1 (block trace, corresponding to the wood oil product in FIG. 6) with the starting solvent (lighter colored lines) for a liquefaction reaction as described herein. FIG. 11B is a GC trace comparing B2 with the starting solvent. B2 closely resembles the starting solvent, suggesting much of this fraction of the product (which corresponds to the heavy wood oil in FIG. 6) is not volatile under the GC conditions.

FIG. 12 is a schematic for the liquefaction process as described herein.

FIG. 13 is a bar graph comparing the effect of various catalysts on the molecular weight of the bio-oil products. The catalysts tested included: (i) Molyvan A; (ii) ZSM5; (iii) MFI-40; (iv) MFI-300; (v) Fe-MFI; (vi) Pt-ZSM5; (vii) Ni-ZSM5; (viii) Pt-Alumina; (ix) Ni powder; (x) FeCl₃; (xi) Fe₂CO₃; (xii) Na₂CO₃. In each test reaction, 2.5 g Southern Mesa Pine (3 mm), 0.5 grams water, 1.75 grams catalyst, and 7.5 g tetralin and catalyst were added. No hydrogen was added to the reaction. The molecular weight distribution of the bio-oil product was determined by gel permeation chromatography. FIG. 13 shows that when a catalyst is added to the liquefaction reaction described herein, the bio-oil product has a significantly lower average molecular weight than when no catalyst is added.

FIGS. 14A, 14B, and 14C are graphs comparing the effect of (i) no catalyst, (ii) Molyvan A, (iii) HV0516 zeolite, and (iv) C2319-23 zeolite on the molecular weight of the bio-oil products from the liquefaction reaction. FIGS. 14A-C show that when a catalyst is added to the liquefaction reaction described herein, the bio-oil product has a lower average molecular weight than when no catalyst is added.

### MODES OF CARRYING OUT THE INVENTION

The following description sets forth exemplary methods, parameters and the like. It should be recognized, however, that such description is not intended as a limitation on the scope of the present proposed invention but is instead provided as a description of exemplary embodiments.

“Biomass” as used herein refers to plant-derived materials, which may be by-products (e.g., from pulp production for paper), recycled wastes (e.g., lawn clippings and the like), or purpose-grown plant materials (e.g., switchgrass or similar biomass crop plants) intended for conversion into fuel, etc., as described herein. Biomass is typically biologically produced solid material that is not readily soluble in water or typical solvents, and which can be used as a source of organic materials or fuel. Biomass used for the process described herein typically comprises a mixture of lignins and cellulose, and optionally other plant-derived materials. Optionally, switchgrass for this process can be produced by known intercropping methods on forest land, where the switchgrass is grown as a biofuel feedstock in the spaces between trees growing for timber harvest.

“Hydroprocessing” as used herein refers to reactions in the presence of a catalyst and hydrogen at elevated temperature and pressure, used for modification of organic materials (e.g. biomass, petroleum products, coal and the like). Typically, hydroprocessing provides a more volatile product, often a liquid. It can include hydrogenation, isomerization, deoxygenation, and the like. Hydroprocessing can include hydrocracking and hydrotreating. It typically removes components that lower the quality, usability, or energy content of the product, such as metals, oxygen, sulfur and/or nitrogen.

“Lignin” as used herein refers to a group of phenolic polymeric materials that bind cellulose together in woody materials. Lignin comes from a variety of sources, including paper mills and wood processing facilities, and fermentation by-products, and from grasses, softwoods, hardwoods, and similar biomass materials. Lignin is generally not consumed or converted by typical fermentation processes, and methods to produce renewable carbon feedstock for synthesis of biofuels from lignin would be of great value. Lignin-containing biomass includes raw wood and partially processed wood products, as well as cellulose-depleted materials where lignin may be produced as a by-product of paper production, for example.

“Liquefaction” as used herein refers to conversion of at least a portion of a substantially solid biomass material to produce a liquid fraction or into components that are liquid or are soluble in liquid carriers used in the process. The product of liquefaction is a liquid or suspension or slurry, which may be separated from any residual solids or solid by-products.

“Cellulose” or “cellulosic material” as used herein refers to holocellulose, which is the collective polysaccharide-containing material in raw plant products such as wood that contains the saccharide linkages characteristic of cellulose. It includes cellulose and hemicelluloses.

“Green crude” as used herein is a generic term for partially processed plant-derived oil products that are highly oxygenated and require further processing, such as hydroprocessing and various other modification and/or separation processes, to become a useful liquid fuel product. The bio-oil produced by the methods described herein is a green crude.

“Recycle stream” as used herein refers to a liquid produced by a process such as the liquefaction process described herein that is recycled to provide an input for the same process. For example, a portion of the green crude or bio-oil product from the liquefaction process described herein can be collected or redirected to provide one of the solvent components of the liquefaction reaction. Typically the recycle stream will have a boiling point below 350° C., preferably between about 180° C. and 343° C.

“Refinery” and “refinery stream” as used herein refer to a petroleum processing facility and to a liquid stream processed in a petroleum-processing system. The product produced by the liquefaction reaction described herein can be added to a refinery stream, because it is compatible with petroleum refinery streams and processing methods.

The novel methods of the invention use a solvent-enhanced liquefaction process to convert biomass solids into liquid form for transportation and/or further processing. The methods involve heating biomass under pressure with selected organic solvents to solubilize much of the biomass material, providing a liquefied product and optionally residual solids. The selected solvents provide efficient liquefaction under the temperature and pressure conditions described herein. They also do not interfere with subsequent processing and utilization of the bio-oil product, and thus do not have to be separated from the bio-oil product. Residual solids can be mechanically removed, either by decantation of the liquid, or by e.g. filtration methods, to provide a crude liquid product, or by flash drum separation of the volatiles from insoluble materials, which are generally non-volatile. The process results in sufficient depolymerization and chemical modification of the biomass to produce a liquefied product that can conveniently be handled by liquid processing methods and equipment.

The novel solvent liquefaction process produces biocrude in very high yields with improved product qualities compared to the current generation of fast pyrolysis reactors, without using expensive catalysts or excessive hydrogen inputs. The new process integrates closely with a refinery by both using a refinery-generated byproduct as makeup solvent (to enhance the normal thermal conversion processes) and by utilizing the refinery excess hydrotreating capacity to upgrade the biocrude to drop-in hydrocarbons. The process does not require biomass particle size to be as small or moisture content as low as for the gasification or pyrolysis processes. The novel process also produces a high biocrude yield with substantially reduced oxygen content, leading to attractive economics.

The novel process achieves oxygen rejection (reduction) by forming water and/or carbon dioxide, carbon monoxide, and some water-soluble organics. These are readily separated from the biocrude product so that the biocrude product can be further processed. This oxygen rejection reduces the amount of hydrogen require during hydroprocessing of the bio-oil from the new methods. Depending on the biomass feedstock, yields between 100 and 120 gallons of oxygen-free transportation fuels can be produced by these methods, while less than 10% of the biomass is converted into insoluble char.

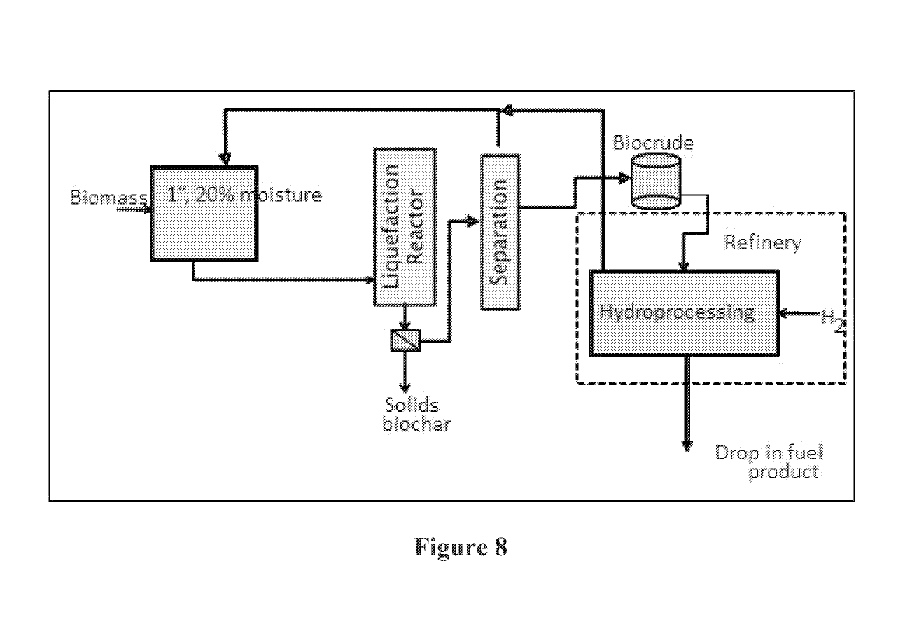

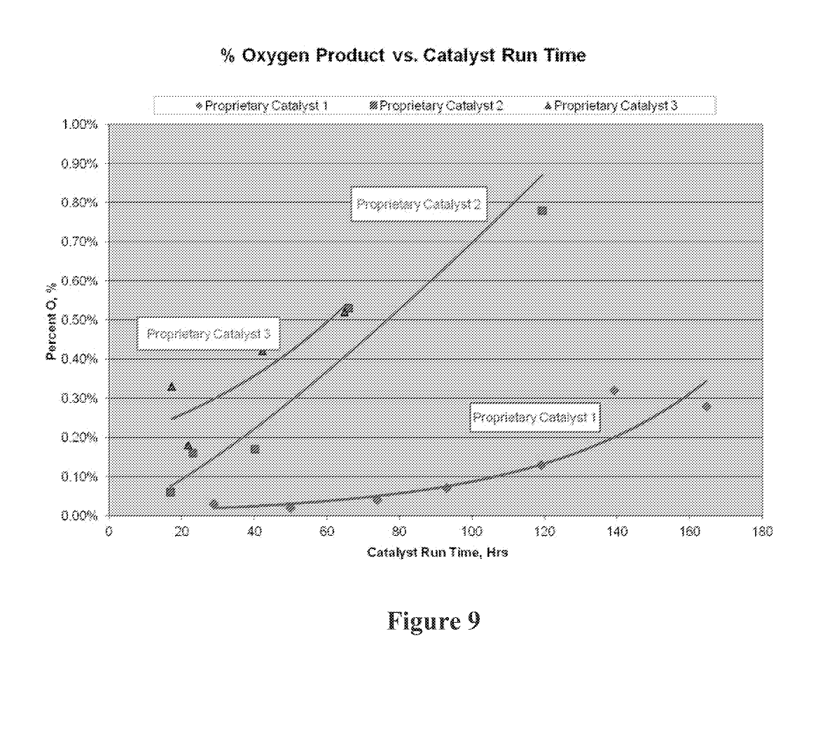

In one implementation of the new process, biomass is slurried with a recycle solvent stream that consists of a selected fraction of the separation unit, supplemented with a small makeup flow consisting of a refinery hydrocarbon stream (FIG. 8). The slurry is continuously pumped into a moderate-temperature (˜380° C.), moderate-pressure (between 400 and 800 psi depending on the recycle stream) reactor where it is converted to liquid product and waste gas with small amounts of residual char. Char can be removed in a flow-through process by filtration or similar methods as described herein. The biocrude is then shipped to a refinery for hydroprocessing. After hydroprocessing the hydrocarbon product is a finished “drop-in” fuel. The use of an existing refinery for hydroprocessing and solvent production reduces the complexity and capital cost of the liquefaction plant.

### Biomass

The methods described herein convert biomass into a liquid bio-oil product. The biomass is typically plant material, and is thus a renewable resource. The biomass comprises organic compounds that are relatively high in oxygen, such as carbohydrates, and may also contain a wide variety of other organic compounds. It is typically mostly solids such as wood products and the like.

In some embodiments, the biomass for this process comprises lignin and/or cellulose. Optionally it may contain hemicelluloses, plant-derived oils such as terpenes, and the like. Any source of biomass can be used; some typical examples are described herein. Typically, the biomass contains significant amounts of both lignin and cellulose, e.g., at least about 10% by weight of each. Wood chips or particles can be used as a suitable biomass.

Prior art methods for fast pyrolysis of biomass generally require the biomass to be relatively dry and small in size, which significantly increases the cost of the process. The biomass for this process need not be dried for use; typically, the biomass has a moisture content of about 10% to about 70%. Wood or wood byproducts can be used, as well as sources such as switchgrass, hay, corn stover, cane, and the like. Frequently, the biomass comprises a mixture of lignins and cellulose materials. Typically it contains at least about 10% lignin on a dry-weight basis.

Many types of biomass can be used in the methods of the invention. Wood chips or similar raw wood residues are suitable for use, either alone or in combination with other biomass materials. Such woody materials tend to be high in lignin content. Similarly, grassy materials such as switchgrass, lawn clippings or hay can be used, either alone or in combination with other biomass materials. Grassy materials tend to contain large amounts of cellulose and lower lignin ratios. Partially processed materials, such as solid residues from wood pulp production can also be used. In some embodiments, a mixture of different types of biomass is used; ideally, the biomass will comprise significant amounts (e.g., at least about 10% by weight) of both lignin and cellulose. Mixtures containing both lignins and cellulose have been found to be most efficiently liquefied by the methods described herein. Thus it may be useful when processing lignin-rich materials, or cellulose-depleted ones like fermentation by-products, to add cellulose-rich materials such as grasses to provide an optimal balance of components in the biomass.

Biomass for use in the methods described herein can be prepared by conventional methods known in the art, such as chipping, grinding, shredding, chopping, and the like. As a general matter, comminution of biomass by mechanical methods to provide smaller particles and/or increased surface area can reduce the processing times, temperatures and pressures required to produce a liquefied product. However, a finely divided biomass is not essential to the operability of the present methods. The biomass is generally made up of discrete pieces. In typical embodiments, the biomass is divided into pieces under about one inch in thickness in smallest dimension, and under about 25 square inches of surface area on their largest surface. In some embodiments, at least 75% of the discrete pieces have a greatest dimension of at least about one inch. In another embodiment, the discrete pieces have a greatest dimension of about 3 inches. The pieces can be of regular shapes, but typically they are irregular in shape. In some embodiments, the average piece has a thickness up to about one centimeter and a largest surface of about 25 square centimeters. In some embodiments, the biomass is divided into pieces small enough so that most of the mass (e.g., at least about 75% of the biomass) can fit through 1-cm diameter sieve holes. Material can optionally be finely divided, where the majority of the material can pass through 7 mm holes or through 5 mm holes when sized or sieved.

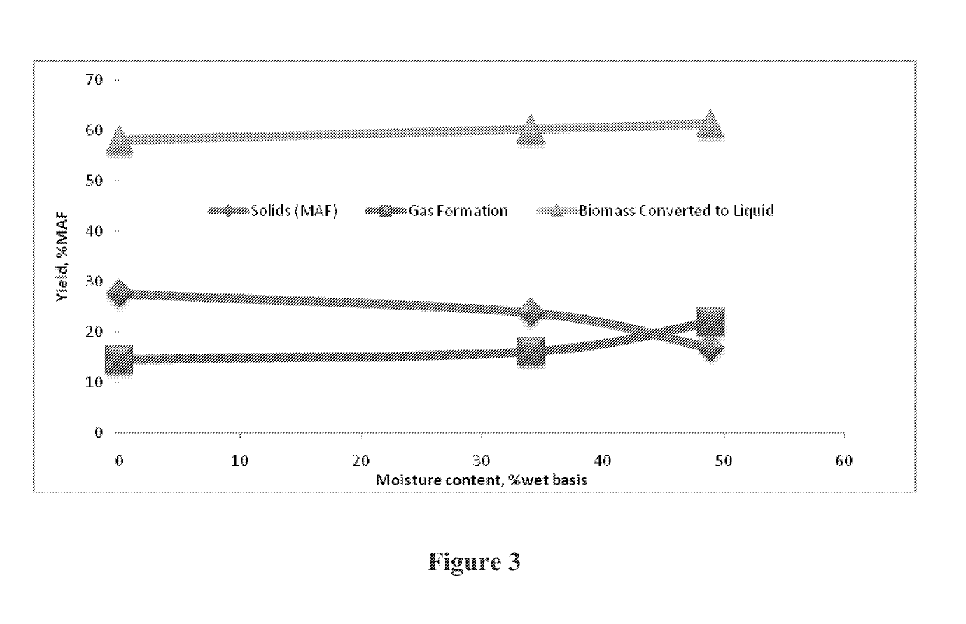

Unlike some methods in the prior art, it is not necessary to dry biomass for use in this solvent liquefaction method. Eliminating the need for pre-drying biomass substantially improves the overall efficiency of the processes described herein. Indeed, it is beneficial to have some moisture present. Without being bound by theory, it is believed that water present during the liquefaction process reduces formation of solid polyaromatic products and favors desired reactions, perhaps by intercepting some highly reactive species that would otherwise participate in polymerization to form insoluble by-products. As shown in FIG. 3, the presence of some moisture in the biomass slightly increases biomass conversion, and slightly decreases solid formation. Thus having a moisture content of between about 10% and about 70% may be advantageous. In some embodiments, the biomass used has a moisture content of over 10%, such as at least about 15%. In other embodiments, the biomass has a moisture content of at least about 25%. The ability to use plant-based feedstocks without drying is a very significant advantage over known methods, since it reduces the processing costs to be competitive with costs of petroleum-based fuels, while providing a product having a higher energy content than pure ethanol.

Nevertheless, partially drying the biomass to be used is an optional step that can promote consistent results, and thus can be included in the process. In some embodiments, the biomass used has a moisture content between about 25% and about 60%. Thus while drying is not generally essential, biomass may still be dried to a degree in order to provide consistency in processing and products, and the increase the overall process efficiency by reducing the energy input to the reactor vessel required for sensible and latent heating of the excess moisture in the biomass. Thus, a system to implement the methods described herein may optionally include a drying step or a drying chamber to remove some moisture from the biomass as needed.

### The Solvent Mixture

The solvent combination used for this process is novel. It includes a make-up solvent, which can be a mixture of solvents and can include tetralin or methyl naphthalene, for example. Use of make-up solvents is known in the art for similar applications: under the reaction conditions, the make-up solvent can transfer hydrogen to components of the biomass material. Contrary to the reported literature for coal liquefaction, we have found that solvents containing significant amounts of fused three aromatic ring solvents, such as anthracene and phenanthrene, adversely affect product yields and should not be in significant concentrations in the make-up solvent. This can reduce the oxidation level of the biomass, and can also reduce the oxygen content of the bio-oil product and thus improve the fuel value of the product. The process also makes the bio-oil product compatible with petroleum refinery streams for co-processing.

Typically, the total amount of solvent in the solvent combination will be at least about 50% of the mass of the biomass to be treated, and it will commonly be at least about 100% of the mass of the biomass to be treated. In some embodiments, a solvent to biomass ratio of at least 2, or at least 3, or at least 4, or at least 5 can be used.

Previous solvent-based biomass liquefaction methods often used a hydrogen donor solvent in large quantities for solvent liquefaction; the present methods accomplish liquefaction with lower quantities of hydrogen donor solvent, if any. In the present methods, the amount of hydrogen donor solvent can be about the same (by weight) as the amount of biomass for a given batch process, or it can be lower. Moreover, much lower amounts of hydrogen donor solvent can be used in the present methods, and in some embodiments the amount of the hydrogen donor solvent is about half or less than half of the amount of biomass used (by weight). In some embodiments, the amount of hydrogen donor solvent is up to about half of the weight of the biomass to be treated, e.g., about 0% to about 50%, or up to about 25%. In some embodiments, it is about 5% to about 25% of the weight of biomass to be treated, or between 10% and 25%. A dry weight may be used for the biomass in this ratio for consistency, even though moist biomass may be used in the process. The ability to operate with low volumes of hydrogen donor solvent is an important advantage of the present methods over earlier methods, because the hydrogen donor solvent is typically produced in a separate operation or at a remote site. When using prior methods, the hydrogen donor solvent imposed either a high capital cost, by requiring the user of a solvent liquefaction biomass conversion to provide a facility for preparing hydrogen donor solvent; or it imposed a high transportation cost, by forcing the user to deliver large amounts of hydrogen donor solvent (or hydrogen) to the biomass liquefaction site on a continuing basis. A facility operating by the methods described herein, by contrast, can use significantly smaller amounts of a hydrogen donor solvent, or none, providing an important advantage. In addition, as further explained herein, the make-up solvent can be provided by a petroleum refinery, and the bio-oil product of the liquefaction process can also be introduced into the refinery's hydroprocessing input stream, which reduces transportation costs and simplifies logistics.

### The Liquefaction Solvent

In one aspect, the invention provides a process for liquefaction of biomass, which comprises combining biomass with a solvent combination comprising at least one liquefaction solvent that promotes liquefaction and at least one make-up solvent. This mixture of solvents and biomass is held in a pressurized container, and heated to a temperature of at least about 250° C. to produce a crude reaction product comprising a liquid bio-oil product.

The novel solvent combination used herein comprises at least one liquefaction solvent that differs from the make-up solvent, which is further described below. The liquefaction solvent is important to the effectiveness of the process: it is believed that the liquefaction solvent helps to solubilize materials formed by depolymerization or degradation of biomass components, and thereby reduces the tendency of these materials to form insoluble by-products such as coke or char. The liquefaction solvent has a Hansen radius of interaction with coniferyl alcohol of less than 15 MPa^{1/2}. The liquefaction solvent can comprise from about 5% to about 90% of the total solvent used in the liquefaction mixture. Frequently, the liquefaction solvent comprises 15% to 80% of the total solvent used. The liquefaction solvent may also contribute to making the bio-oil product compatible with petroleum-derived process streams, enabling the product to be introduced into a refinery stream for further processing into a transportation fuel or similar products.

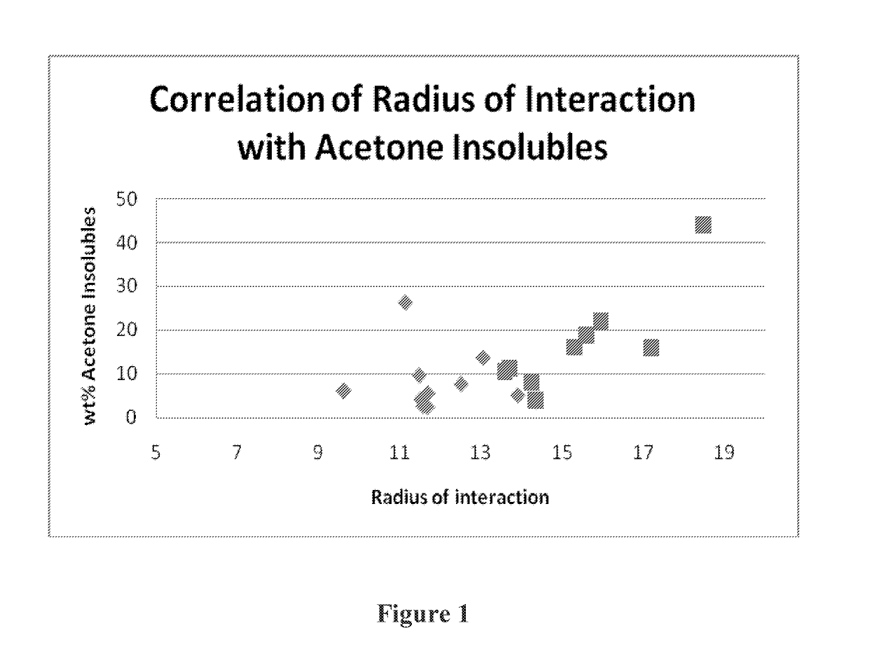

A variety of solvents or a mixture of solvents can be used as the liquefaction solvent for this process, but particularly suitable solvents can be selected according to their solvent properties as measured by Hansen parameters. The liquefaction solvent can be one solvent or a mixture of solvents, and the Hansen parameters provide a useful way to select a solvent or solvent mixture for this purpose. Solvent properties as measured by Hansen parameters that are suitable to dissolve the bio-oil product and many of the early biomass degradation products are believed to also minimize formation of solids during the liquefaction reaction. In particular, it has been found that it is desirable to have a liquefaction solvent or solvent mixture that has a Hansen radius of interaction with coniferyl alcohol of less than 15 MPa^{1/2}, preferably about 14 MPa^{1/2} or less. FIG. 1 shows that such solvents promote conversion of biomass into liquids with minimal solids present. Conversions of 90% or more of the biomass into liquid or gaseous products (non-solids) was achieved with most solvents or mixtures of solvents having a Hansen radius of interaction less than 15 MPa^{1/2}, especially between about 9 MPa^{1/2} and about 14 MPa^{1/2}.

Suitable solvents for the liquefaction solvent often comprise an oxygenated solvent: the diamond symbols in FIG. 1 represent solvents or solvent mixtures that include an oxygen-containing solvent, and most of them fall in the target range for Hansen radius of interaction and also perform well. The square symbols represent non-oxygenated solvents or mixtures, though, and some of them are also suitable liquefaction solvents, e.g., tetralin alone, which has a Hansen radius of about 14 MPa^{1/2} (specifically, 14.4 MPa^{1/2}) and produced less than 5% insoluble materials. Thus, the Hansen radius parameter of a particular solvent predicts its usefulness as the liquefaction solvent in these methods better than the presence or absence of oxygenation in the particular solvent.

Not all of the compounds having the desired Hansen radius of interaction provided good results in FIG. 1: one outlier where higher amounts of solids were produced was a solvent mixture that included vanillin, which had a seemingly good Hansen radius (about 11 MPa^{1/2}). Vanillin is an aldehyde, and is not generally considered a solvent because of its reactivity. Under the reaction conditions for liquefaction, it is believed that this material polymerizes with itself or promotes polymerization of other components in the liquefaction mixture. Thus, in addition to having a suitable Hansen radius of interaction, the solvent or solvent mixture should also consist mainly of materials that are not prone to polymerization under the operating conditions of the liquefaction process; solvents containing significant amounts of materials that polymerize under the liquefaction conditions would not be suitable. Thus, in some embodiments, the liquefaction solvent does not contain significant amounts (e.g., no more than about 10% by weight, preferably less than 5% by weight) of compounds having reactive functional groups such as aldehydes that participate in polymerization under the liquefaction reaction conditions to be used.

When the solvent combination includes a liquefaction solvent or solvent mixture having a Hansen radius of interaction about 9-14 MPa^{1/2}, the make-up solvent can constitute less than about 25% of the solvent volume (e.g., about 5-25%), and liquefaction conversion of up to 95% or higher can still be achieved. Some exemplary and non-limiting components that can be used as this liquefaction solvent (or as components of the liquefaction solvent) include sinapyl alcohol, p-coumaryl alcohol, phenol, 2,6-dimethoxyphenol, 3,5-dimethyl phenol, guaiacol, m-cresol, phenoxypropanol, 1-butanol, tetrahydrofuran, naphthalene, acetone, 1-methylnaphthalene (MNP), tetralin, and mixtures of these. Mixtures are selected to have a Hansen radius of interaction less than 14 MPa^{1/2}, or between 9 MPa^{1/2} and 14 MPa^{1/2}.

A suitable liquefaction solvent for the liquefaction methods herein is a green crude product, such as the bio-oil produced by the methods described herein. These are typically oxygenated materials, containing aromatics derived from lignin, and often exhibit the desired Hansen radius of interaction as discussed above, i.e., less than 15 MPa^{1/2}, or between 9 MPa^{1/2} and 14 MPa^{1/2}. Preferably, a fraction of a green crude having a boiling range below about 302° C. is used, and typically the fraction boils in a range between about 160° C. and 280° C., and often between about 180° C. and about 250° C. The bio-oil produced by the instant methods is an example of a suitable green crude, and fractions with a boiling range between about 160° C. and 280° C. are useful as the liquefaction solvent for the methods described herein.

One way to provide a suitable liquefaction solvent for the solvent combination used for the liquefaction methods described herein is thus to use a recycle stream from the liquefaction process described herein. The recycle stream has very suitable solvent properties and offers the advantage of ready availability: it is produced at the site of liquefaction, so it does not need to be transported at all, just redirected from the output stream to become part of the input for the reaction container. Preferably, a recycle stream used for this purpose has been separated from the crude liquefaction product by distillation, extraction, flash purification, or adsorption, or some combination of these. The methods and fraction used are preferably selected to minimize the Hansen radius of interaction, or at least bring the Hansen radius of interaction below about 14 MPa^{1/2}. The methods and fractions used ensure and optionally maximize the presence of oxygenated compounds such as phenols. If prepared by distillation, a preferred fraction of the crude liquefaction product or of the bio-oil product for use as this recycle stream has a boiling range below about 343° C.; typically between about 160° C. and 280° C., and often between about 180° C. and about 250° C. Thus, a fraction of the bio-oil or a recycle stream produced by the methods herein can be used as a liquefaction solvent for the liquefaction process. Preferably, it is a fraction boiling in the temperature range between about 160° C. and 280° C., and often between about 180° C. and about 250° C.

### The Make-Up Solvent

The solvent combination used for these methods contains at least one make-up solvent, and may contain a mixture of make-up solvents such as those described herein. Typically, the solvent combination comprises about 1% to about 50% make-up solvent by volume, often between about 10% and 30%. Frequently, the amount of make-up solvent used is between 1% and 100% of the amount of biomass on a dry weight basis, and preferably it is between 5% and 50% of the amount of biomass on a dry weight basis, such as about 20-30%. Optionally, the make-up solvent may comprise a refinery stream produced in a separate process. Alternatively, the make-up solvent may comprise a portion of the product of the instant process that has optionally been partially hydrogenated to function as a make-up solvent.

The make-up solvent may have some capacity to act as a hydrogen donor solvent, though this is not required. In some embodiments, a partially hydrogenated refinery stream used herein is one with the ability to act as a hydrogen donor solvent.

One suitable make-up solvent is a cycle oil or refinery stream from a refinery, in particular a light cycle oil (LCO). The LCO as used herein is a highly aromatic refinery stream boiling in the range of 180-350° C. The LCO is typically a refinery cycle oil from petroleum refining processes, such as those known in the art. For use in the current method, the LCO that distils below 343° C. (650° F.) or below about 300° C. is preferred; the LCO can be prepared by distillation to remove higher boiling components. The LCO can include 1-methyl naphthalene.

The refinery is typically a separate facility from the biomass processing facility described herein, and can be one operating with petroleum inputs as a major feedstock. The solvent mixtures employed herein enable mixing of the instant biomass conversion streams and products with typical liquid refinery streams by promoting miscibility; moreover, they enable the processes described herein to produce product that can be blended with typical refinery streams, including petroleum-derived refinery streams, for subsequent co-processing. The refinery stream can be with which the bio-oil product is blended can be from a stage prior to hydroprocessing, or it can be a product of hydroprocessing.

While cycle oils in general can be used as the make-up solvent, light cycle oil provides better conversion of biomass. Some suitable cycle oils include refinery streams containing tetralin, tetrahydroanthracene, tetrahydrophenanthrene, substituted tetralins such as methyl tetralin, ethyl tetrahydroanthracene, and the like. These are typically petroleum-derived refinery streams. Other aromatic or partially hydrogenated aromatic refinery streams can also be used, preferably ones that have been shown to act as hydrogen donors. However, the LCO does not necessarily have the ability to function as a donor solvent as long as it qualifies as a liquefaction solvent, as described above.

Light cycle oil (LCO) as used herein is a highly aromatic refinery stream boiling in the range of 180-350° C. The LCO is typically a refinery cycle oil from petroleum refining processes, such as those known in the art. For use in the current method, LCO that distils below 343° C. (650° F.) or below about 300° C. is preferred; the LCO can be prepared by distillation to remove higher boiling components.

In some embodiments, the solvent combination includes a refinery stream product that is a light cycle oil (LCO) having a boiling range below about 343° C. In some embodiments, a portion of the crude reaction product from the above-described process is separated to form a solvent recycle stream, which is used as part of the solvent combination for use in the process. In such embodiments, the portion of the crude reaction product that is recycled typically has a boiling range between about 180° C. and 343° C.

It is possible, too, to treat the recycle stream or bio-oil made by these methods to provide part or all of the make-up solvent needed for the liquefaction process, by adding hydrogen to it. A similar approach has been used, for example in U.S. Pat. No. 4,133,646, which describes a solvent liquefaction of coal. This may reflect the presence of residues from tetralin or other make-up solvents that distil in the range used to prepare the recycle stream as described above. To provide a make-up solvent, the recycle stream is hydrogenated using a catalyst to introduce some accessible hydrogen; the hydrogenated recycle stream (or bio-oil) can then function as a make-up solvent. However, if using a recycle stream in this way, it is important to hydrogenate only a fraction (typically less than half, optionally up to about 25% or up to about 15%) of the recycle stream that is to provide both the hydrogen donor and liquefaction solvent functions. If the entire recycle stream is fully hydrogenated, deoxygenation can be too extensive, modifying the solvent properties of the material and lowering the usefulness of the hydrogenated recycle stream as the liquefaction solvent in the liquefaction methods.

Thus, a hydrogenated bio-oil or recycle stream can be used to provide the hydrogen donor function, and this can be used in combination with any suitable liquefaction solvent having a Hansen radius of interaction with coniferyl alcohol up to about 14, including bio-oil or a bio-oil fraction. In this manner, it is possible to avoid importing make-up solvents for use in the liquefaction process, since recycled bio-oil can provide both the make-up solvent and the liquefaction solvent; but doing so still requires enough hydrogen to hydrogenate part of the bio-oil (or recycle stream) to provide make-up solvent amounting to at least about 5% of the biomass to be treated.

In some embodiments, the make-up solvent is converted into a make-up solvent product under the liquefaction conditions that is suitable for hydroprocessing while mixed with the bio-oil product derived from the biomass liquefaction. This eliminates the need to separate the make-up solvent or its product formed during the liquefaction process from the liquefaction product stream for further processing. Further processing of the bio-oil produced by the methods described herein can include hydroprocessing, and/or feeding the bio-oil product to a catalytic cracker; this can involve co-processing of the bio-oil product with a petroleum refinery stream. The make-up solvent facilitates this process by helping to make the bio-oil product miscible with a petroleum refinery stream.

### Specific Solvent Components

In some embodiments, the solvent combination comprises at least one phenol, and significant amounts of phenols or aromatic alcohols can be advantageously used. A mixture of phenolic compounds and/or aromatic alcohols can be used as well. The phenolic compounds and/or aromatic alcohols may be derived from biomass, and may be provided by a biomass processing stream; they are often formed from lignins during biomass liquefaction, and added to the solvent mixture via a recycle stream. Alternatively, commercially available phenolic compounds can be added. Suitable phenolic compounds include phenol or napthol and substituted phenols having up to three substituent groups selected from C1-C4 alkyl, C1-C4 alkoxy, halo, C1-C4 hydroxyalkyl such as hydroxymethyl or hydroxyethyl or hydroxypropyl, and C2-C4 hydroxyalkenyl such as 3-hydroxy-1-propenyl (—CH═CH—CH₂OH). Suitable aromatic alcohols include benzene or naphthalene that is substituted by at least one C1-C4 hydroxyalkyl, or C2-C4 hydroxyalkenyl such as 3-hydroxy-1-propenyl (—CH═CH—CH₂OH), and is further optionally substituted by up to three additional groups selected from C1-C4 alkyl, C1-C4 alkoxy, halo, C1-C4 hydroxyalkyl, and C2-C4 hydroxyalkenyl.

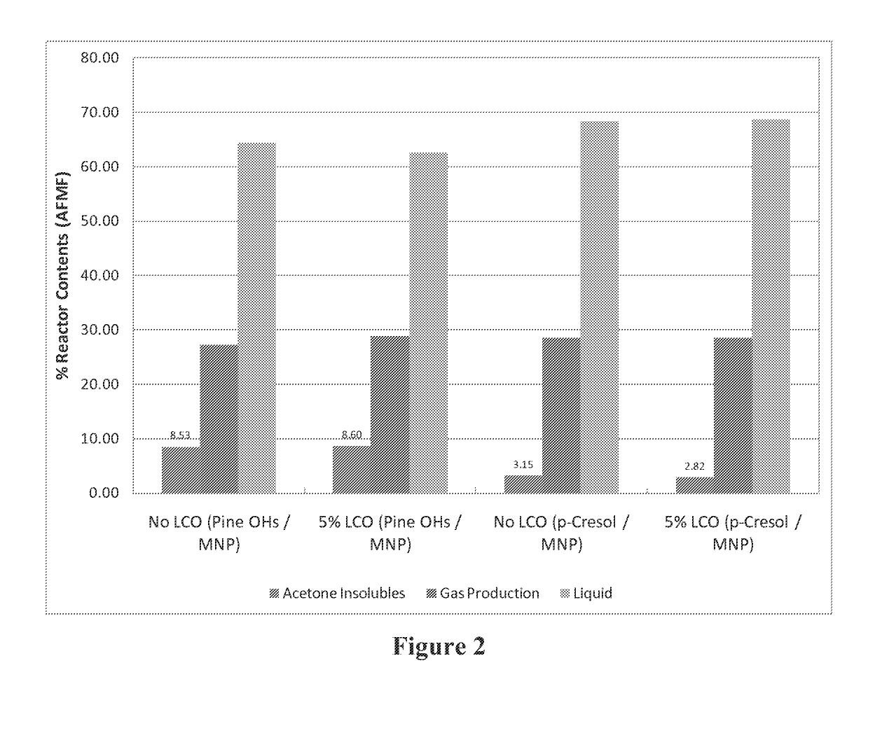

While not required, it is often advantageous for the solvent combination to include at least one phenolic organic solvent, i.e., a solvent comprising a hydroxyphenyl (phenolic) structure or substructure. Such solvents include phenol, sinapyl alcohol, coniferyl alcohol, 3,5-dimethylphenol, m-cresol, p-cresol, o-cresol, vanillin, guaiacol, 2,6-dimethoxyphenol, and the like and may be present in the liquefaction solvent as discussed above. Without being bound by theory, it is believed that phenolic solvents promote dealkylation of alkyl phenyl ethers under the conditions of the liquefaction process. This is thought to help break down some of the linkages of lignin, for example, providing more soluble products and promoting liquefaction. FIG. 2 illustrates the effect of a phenolic compound, p-cresol, on a liquefaction reaction using MNP (1-methylnaphthalene) with or without LCO as a make-up solvent. It shows that p-cresol added to the reaction, with no or low levels of make-up solvent (LCO) in methylnaphthalene produces lower amounts of acetone-insoluble material and higher yields of liquefied products than comparable reactions containing pine oil overheads (‘Pine OHs’) in similar reactions. Phenolic compounds that have a Hansen radius of interaction with coniferyl alcohol under about 14 MPa^{1/2} can thus be useful additives for or components of the solvent combination used for methods of the invention, and can be added to hydrocarbon solvents such as tetralin, methyl naphthalene and the like, to produce a solvent mixture having a desired Hansen radius parameter.

The solvent combination for this process often comprises at least one of the following solvents, and can include a mixture of these solvents in addition to or instead of the above-described phenols and aromatic alcohols: sinapyl alcohol, p-coumaryl alcohol, phenol, 2,6-dimethoxyphenol, 3,5-dimethyl phenol, 2,4-dimethyl phenol, anisole, 2-methyl anisole, 3-methyl anisole, 4-methyl anisole, guaiacol, m-cresol, o-cresol, p-cresol, phenoxypropanol, 1-butanol, tetrahydrofuran, naphthalene, acetone, 1-methylnaphthalene, tetralin, or a green crude or a fraction thereof.

Some of the particular solvents and solvent combinations contemplated are ones used to generate the data in FIG. 1, where conversion appears to be fairly complete, e.g., only about 10-15% or less of the biomass fed into the reaction is accounted for as acetone-insolubles, meaning 85-90% or more of the biomass was successfully liquefied. These solvents have a suitable Hansen radius, and include:
MNP (methylnaphthalene)+LCO+phenoxypropanol
MNP+LCO+guaiacol
MNP+LCO+3,4-dimethylphenol
MNP+cresol
MNP+LCO+cresol
Aromatic 200+LCO
MNP+cresol
MNP+LCO
Tetralin

In each of the mixtures above, various ratios of components can be used, but preferably the combination gives a mixture having a Hansen radius of interaction of about 14 or less, or between about 9 and about 14 MPa^{1/2}.

Where a recycle stream from the crude liquefaction product is included in the solvent combination for the liquefaction reaction, it typically will include useful amounts of phenolic compounds. In some embodiments, the recycle stream is prepared to maximize presence of phenols; and when prepared by distillation, it typically will contain significant amounts of phenols. Optionally, however, phenolic compounds can be added to the solvent combination or to the recycle stream as needed to promote efficient liquefaction. One or more phenolic compounds such as those listed above can be used, alone or in combination. Typically, an amount of phenolic compounds above about 1%, and frequently the amount is above about 5% or even above 10% of the total volume of solvent used for the liquefaction. In some embodiments, the phenolic compounds comprise about 10% or more of the liquefaction solvent or of the solvent combination.

In some embodiments, the solvent combination consists of, or consists essentially of, or consists largely of a mixture of a light cycle oil (LCO), serving as a make-up solvent, and a solvent recycle stream as described above, serving as a liquefaction solvent, and optionally added phenolic compounds. The light cycle oil can come from the refinery that will process the bio-oil made by the liquefaction process. This can be used to provide transportation efficiencies, because the LCO can come from a refinery and the transport facility (e.g., truck) carrying it to the liquefaction site can also be used to transport the bio-oil product from the liquefaction site to the refinery.

The LCO would typically constitute up to about 50% of the volume of the solvent combination; the balance would be mainly or entirely solvent recycle stream. In certain embodiments, the light cycle oil comprises about 1% to about 25% of the volume of the solvent combination, or from about 5% to about 20%, and the balance consists mainly or entirely of solvent recycle stream. Optionally, a phenolic compound or mixture of phenolic compounds may be added, typically in an amount up to about 20% of the volume of the solvent combination.

### Processing Solvent

It has also been found that it can be advantageous to introduce an additional solvent called a processing solvent, such as a low-boiling polar organic solvent (e.g., acetone or methyl ethyl ketone) into the mixture prior to the liquefaction process, or more commonly after liquefaction, to facilitate further processing. This processing solvent will often have a molecular weight up to about 200, and a boiling point up to about 100° C. at atmospheric pressure. Ketone, ester and ether solvents are suitable, and preferably have a boiling point below 80° C. so they can be removed without excessive energy costs. Acetone and MEK are suitable processing solvents.

This processing solvent can be added at any appropriate time; in some embodiments, it is added after the heating cycle has ended, or after the reaction mixture has cooled down significantly from its cooking temperature. The processing solvent can be added directly to the reaction chamber or to the solvents to be used in the reaction, but typically the processing solvent will be added after the liquefaction reaction has been completed. For example, it can be added to the crude product in the reaction container after the liquefaction heating phase has ended, or to the effluent stream containing the product at some point after it exits the reaction container, e.g., before the first separation subsystem (2).

If introduced prior to liquefaction, the processing solvent reduces the amount of insoluble material formed in the reaction; “insoluble” as used in this context refers to material having essentially no solubility in acetone. This improves the quality of the crude bio-oil product and can enhance the yield of bio-oil, too. Adding a processing solvent such as acetone either before or after liquefaction can improve filtration of the product as well, and it facilitates transfer and handling (e.g., filtration) of the reaction product by lowering viscosity, and improves separation of insoluble material.

The processing solvent can be readily removed from the bio-oil product and recycled or reused by conventional methods, or it may be left in the mixture if it is compatible with subsequent processing steps. Commonly, the processing solvent is distilled out of the bio-oil product and can be re-used by being recycled in the liquefaction process.

The amount of this added processing solvent can be selected with ordinary experimentation; suitable amounts are typically at least about 10% of the volume of the liquefaction mixture, sometimes at least 30% of that volume, and optionally a volume of about 50% of the liquefaction mixture or more. Use of a low-boiling solvent like acetone allows the processing solvent to be removed without large energy costs. Typically, the processing solvent will be added before a post-heating filtration step, and will be included in the filtered crude material.

### The Metal Reagent or Metal Catalyst

A metal reagent or a metal catalyst can be used separately or together to enhance the liquefaction process described herein.

a) The Metal Reagent

For example, a metal reagent comprising iron may be added to the liquefaction reaction described herein to lower the oxygen content of the bio-oil product. The metal may be a once through material such as a shredded metal scrap.

b) The Metal Catalyst

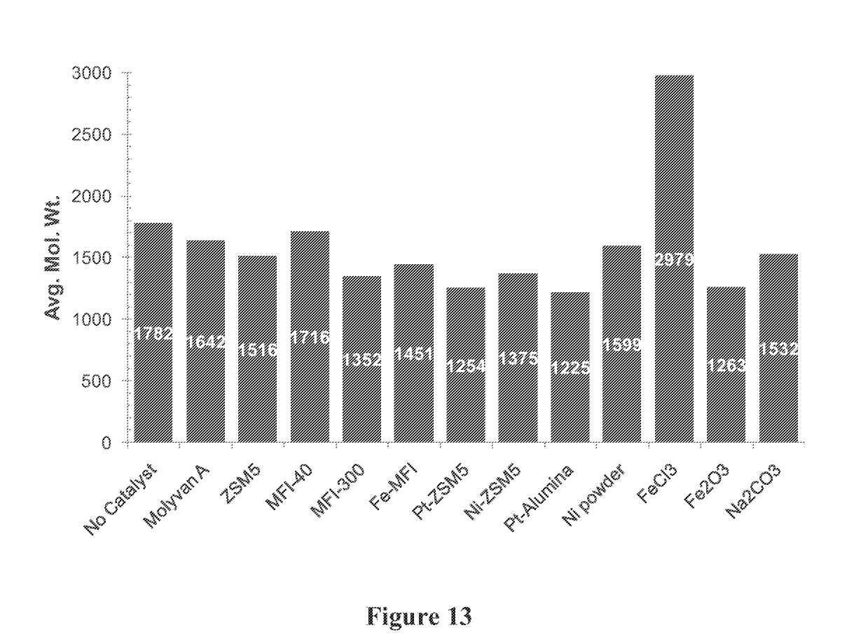

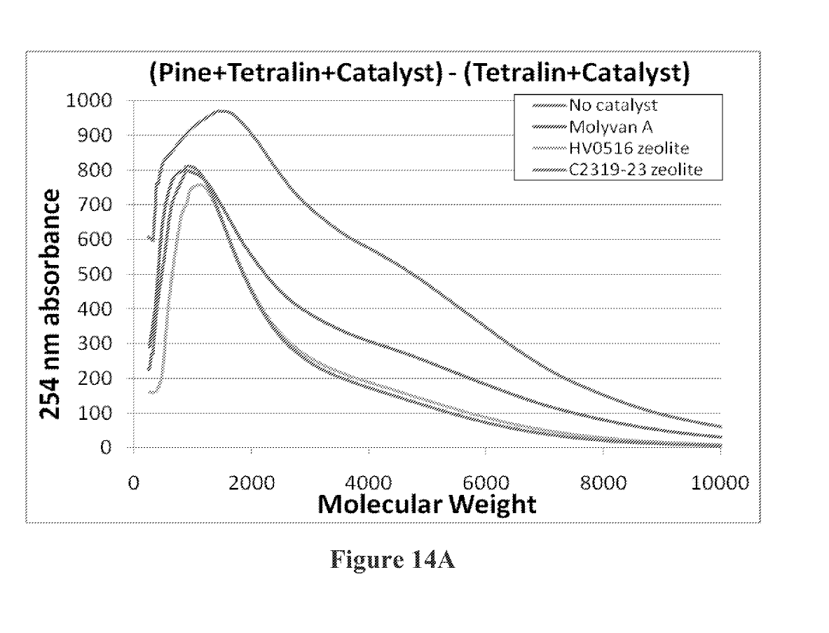

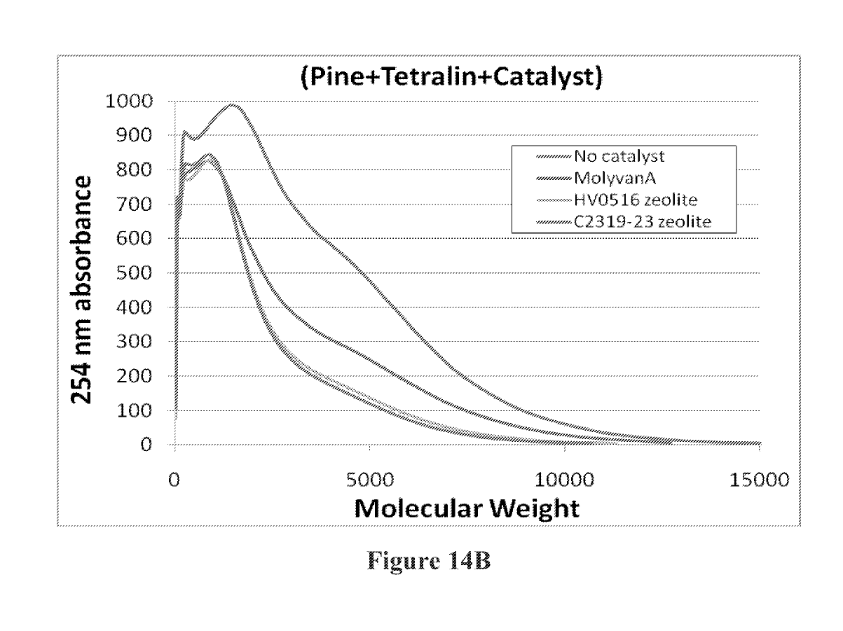

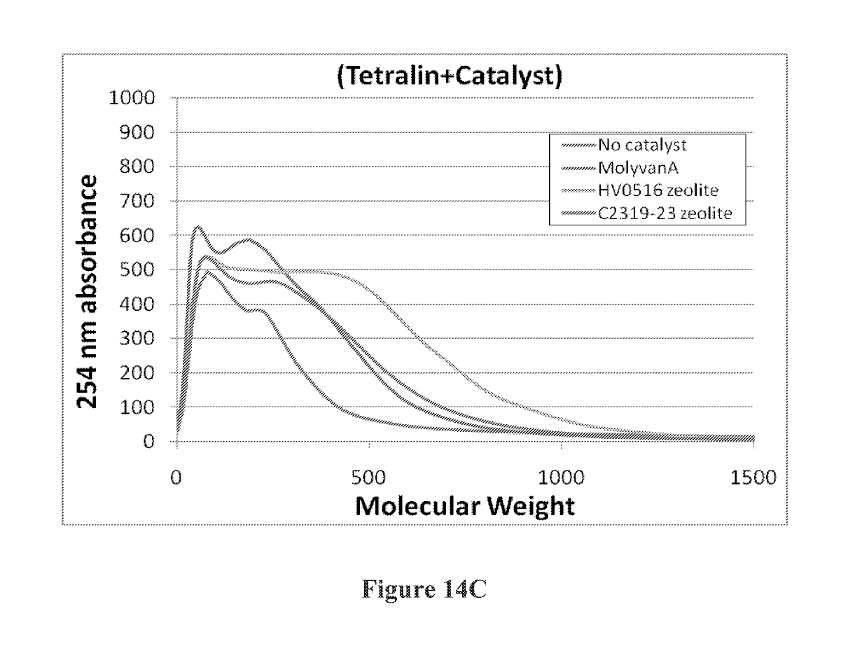

For example, the addition of a metal catalyst, such as a zeolite or a molybdenum salt (e.g., Molyvan A), may reduce the molecular weight of the bio-oil product. As shown in FIG. 13, metal catalysts that may reduce the molecular weight of the bio-oil product include Molyvan A, ZSM5, MFI-40, MFI-300, Fe-MFI, Pt-ZSM5, Ni-ZSM5, Pt-Alumina, Ni powder, and Fe₂CO₃.

### Operating Conditions

The liquefaction process involves heating a mixture of the solvent combination and biomass as described above to a suitable temperature, typically in a container suitable for use at pressures above 200 psi, up to about 1500 psi. In some embodiments, the mixture is heated to a temperature between about 300° C. and 450° C., often up to about 380-420° C. The heating may be maintained for a suitable period of time between about 1 minutes and 5 hours, and typically is continued for a period of time of at least 3 minutes and optionally up to about 120 minutes, often from about 3 to about 20 minutes.

The process is typically performed at pressures above 1 atmosphere, and may be performed in a pressurized container or system at an operating pressure between about 200 psi and about 1500 psi while the reaction mixture is being heated. In a preferred embodiment, the mixture in the pressurized container is heated to a temperature between about 350° C. and 420° C. while the pressure is between about 200 psi and about 800 psi, preferably about 300-600 psi, such as 450-600 psi. Advantageously, the solvent combination permits high conversion at operating pressures below about 800 psi, and frequently operates at 300-600 psi, or 450-600 psi.

The liquefaction process described herein can be conducted in batches or as a continuous flow operation. Parameters of time, temperature and pressure are generally similar for continuous flow or batch processing. In continuous flow mode, the temperature and time parameters correspond to times where the mixture of biomass and the solvent combination are at elevated temperatures, e.g., above about 300° C.

These methods do not require transporting hydrogen to the biomass liquefaction site or locating a hydrogen production facility at the liquefaction site when LCO is used. The process is often performed without adding any hydrogen or CO. Instead, a light cycle oil can be imported to the liquefaction site from a central refinery, and bio-oil produced by the liquefaction process can be exported back to the refinery. Using this method, a single refinery can provide light cycle oil (make-up solvent) for a number of different biomass liquefaction facilities, which can thus be sited locally, near a biomass source that can supply the liquefaction facility. One refinery can then process the bio-oil from multiple liquefaction sources, e.g., multiple different liquefaction systems located at different biomass production sites or accumulation sites.

Beneficially, the bio-oil produced herein can conveniently be further processed along with petroleum based refinery streams, or when admixed with such petroleum-based refinery streams, using known methods including hydroprocessing. The solvent combination used results in a product stream that is miscible with typical petroleum-based refinery streams and is compatible to be blended with and co-processed with such refinery streams. This reduces both capital and transportation costs relative to prior methods, making it a particularly environmentally friendly way to utilize biomass for generating liquid fuels or organic feedstocks.

Extensive experimentation with temperatures for the liquefaction reactions described herein suggests an optimum temperature is generally between about 350° C. and 420° C. In some embodiments, a suitable temperature is in the range of 370-400° C., though it is recognized that the optimum temperature may vary when scaled up to production facilities, and that an optimum temperature can be readily determined for a given system based on the guidance provided herein. Selection of a suitable temperature for a specific combination of biomass and solvent mixture can be done by routine experimentation.

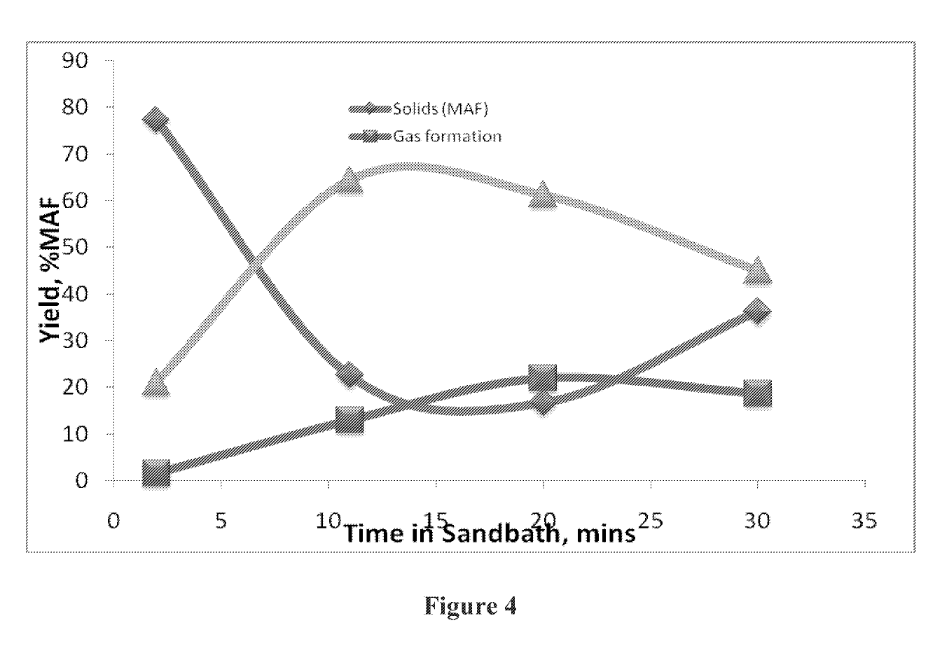

The liquefaction reaction may be heated for a few minutes or up to several hours; typical heating times are expected to be between 2 minutes and about 4-6 hours at the temperature range discussed above, typically for about 3 to 120 minutes. The inventors experimented with heating times using a laboratory set-up, where a relatively constant temperature of about 390° C. was maintained. They found that there was an optimum heating time under these conditions, between about 10 minutes and about 30 minutes. See FIG. 4. Liquefaction is initially relatively rapid, converting solid biomass into liquids and some gases. If heated too long, though, some of the liquids produced begin to form a coke or char, i.e., solid by-products. The optimum time at this temperature is around 15-25 minutes, where the amount of liquid product is maximized.

Based on this information, it is believed that a heating time from about 2 or 3 minutes to about 120 minutes will typically be appropriate when using the methods described herein and at a temperature around 390° C., and heating times of 15-40 minutes may be suitable. This time period will of course vary depending upon the temperature of the reaction (with lower temperatures expected to require longer heating times), and will also depend on other process parameters as well. Under operating conditions where the liquefaction reaction is heated gradually to operating temperature, or where cooling down occurs more gradually because of the scale of the reaction, lower maximum temperatures may be appropriate, and some experimentation will be needed to select a precise duration for heating. Determination of a suitable reaction time for the liquefaction reactions described herein can be accomplished with routine experimentation in view of experiments described here.

The reactions described herein can be conducted without using metal catalysts to promote hydrogenation, which is an advantage over most known processes, wherein a metal catalyst must be added. They also operate without adding hydrogen or carbon monoxide gases as inputs, further reducing costs and increasing the overall energy efficiency of the biomass conversion. Note that because the reaction depends on solvent and temperature rather than a catalyst, some liquefaction can occur outside the reaction container, in zones where the mixture of biomass and solvent combination are held at elevated temperatures. For example, if an extruder is used to feed biomass into the system, liquefaction can occur once solvents are available and the temperatures in the extruder have reached reaction temperature. Similarly, some additional reactions can occur during flash heating or distillation of the crude reaction product.

In addition, the present reactions operate at lower pressures than prior art methods for similar transformations. While the prior art frequently uses operating pressures of 1500 psi or higher, the methods described herein work with operating pressures in the range of 200 psi to about 1500 psi, often below 1200 psi, generally below 1000 psi, and preferably at a pressure of about 300 to about 800 psi, or about 400 or 450 psi to about 600 psi. Higher pressures require more costly equipment and safety measures, as well as more energy to achieve the higher operating pressure; thus the capability of the current process to operate at lower pressures than the methods known in the art provides an advantage over the prior art. The desirable properties of the solvents used herein permit operation at lower pressures, providing significant cost savings.

### Systems for the Liquefaction Process

The methods described herein can be performed with any suitable pressurizable reaction containers, such as those known in the related art discussed herein. Typically, the reaction container will be one suited to operating pressures between about 200 and 1500 psi, e.g., between about 300 and about 800 psi; and operating temperatures up to about 450° C. or 500° C., preferably up to about 420° C. In some embodiments, the methods are performed in a system designed to perform some of the preferred embodiments of the methods described. The system includes at least a reaction container suitable for the temperatures and pressures described herein for the liquefaction reaction; inlets on/into the reaction container to permit addition of biomass and solvents into the reaction container; and at least one outlet for removing product from the reaction container. A solvent delivery subsystem is also optionally included. A heating subsystem is also used.

The system when configured for flow-through operation can be set up to allow gaseous products and steam to vent by top removal, and the liquids and solids (slurry) from the reaction process flow downward. Distillation columns can be used to continuously separate reactor product into desired fractions, including one fraction of suitable boiling range for use as a recycle stream when desired.

Optionally, the system can also include a filtration or other physical separation subsystem to remove undissolved materials from the crude reaction product, and a thermal or chemical separation subsystem capable of separating a portion of the filtered material to provide a recycle stream comprising a fraction of the bio-oil product. This fraction can be selected to have the boiling range and other characteristics described herein that provide a suitable liquefaction solvent for the liquefaction reaction; this fraction can be directed back to the reaction container, or to the solvent delivery subsystem. Optionally too, this fraction can be split so that a portion of it is treated via hydrogenation to function as a make-up solvent, which would also be directed back to the reaction container or to the solvent delivery subsystem. The output not used for a recycle stream becomes, once filtered, the bio-oil product of the process.

The system can also optionally include receiving and preparation equipment to prepare biomass for use in the liquefaction process, as well as a subsystem to feed biomass into the reaction container. Waste handling subsystems can also be provided to remove waste solids or gases from the liquefaction process. The system can optionally further include a subsystem to capture the bio-oil effluent. Optionally, too, the system can include an outlet for collecting gases produced in the liquefaction process. These gases and/or solids removed from the crude product by filtration, or any left as unconverted biomass, can be captured and used (e.g., burned) to provide heat for the liquefaction process. Further processing subsystems, such as a hydroprocessing system or additional extraction, distillation, adsorption, or filtration systems can also be included.

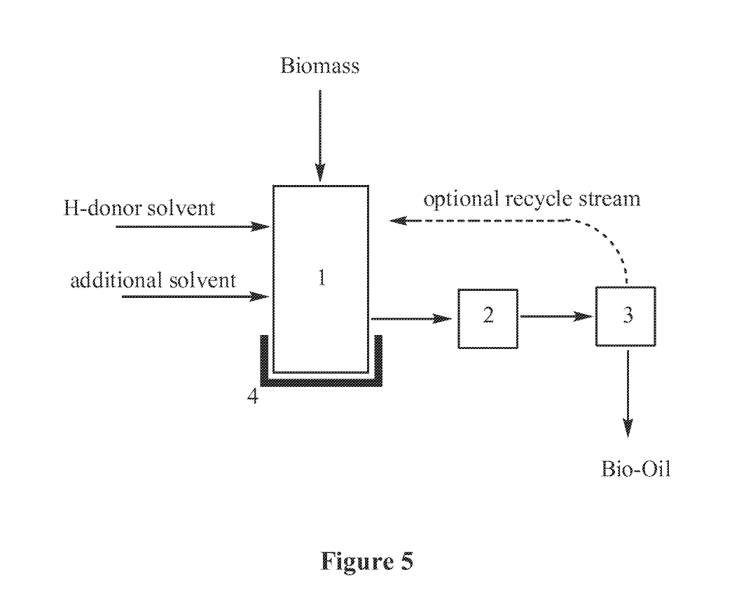

An exemplary system for performing the methods described herein is depicted in simplified form in FIG. 5. This diagram shows a reaction container (1) having inlets to permit introduction of biomass, make-up solvent, and liquefaction (‘additional’) solvent. The system will typically also have pressure and temperature sensors for monitoring the reaction conditions, and may also include mixing apparatus suitable for blending the biomass-containing composition is used to process. It is understood as explained herein that the ‘reaction container’ can be a vessel or pot, or it can be a pipe or similar flow-through system; where the container is a pipe, feature (1) would represent the portion of the pipe within a heated zone, where the liquefaction reaction occurs.

An outlet is provided in reaction container (1) also, so crude product from the reaction container following liquefaction can be removed. In the diagram, crude product is conducted from the reaction container to a separation subsystem (2) such as a filtration subsystem or that separates the liquefied products from remaining solids. The first separation subsystem can be a filtration apparatus, a settling system, or a flash drum, for example, to separate the liquid product from insoluble materials.

The crude liquid material is then conducted to an optional thermal or chemical separation subsystem (3), such as a distillation apparatus. This subsystem can be used to process the filtered material, if desired, to produce a recycle stream that can be used as a liquefaction solvent for the liquefaction process. It would then remove only a portion of the liquid product, and any of the liquid product not used for a recycle stream is typically collected as the bio-oil product. This product can be introduced into a refinery processing stream, typically into an input stream for hydroprocessing; it can be introduced alone or as part of a petroleum-based refinery stream where it would be co-processed with a petroleum stream prior to hydroprocessing. Methods for design and construction of the refinery system are well known to those in the art and can readily be accomplished based on the disclosures herein and conventional engineering principles.

Solids removed from the crude product stream (e.g., residues captured by filtration of the crude product), and/or gases collected from the reaction container, can optionally be used to heat the reaction container via a heating element (4). Alternatively, heating can be provided by conventional electrical resistance heating elements or by direct heating from a combustion process, or by indirect heating using heated air or superheated steam, for example.

Throughout the application, compositions of materials are described with regard to specific materials to be used, such as solvents for the solvent combinations used in the processes herein. It is also within the scope of the invention to use the specified solvents with or without other materials that would typically be deemed suitable by the person of ordinary skill in the art. In some embodiments, the recited materials are used alone, i.e., the composition being described consists of the specified materials. In other embodiments, the recited solvents are the main components, but other materials having only modest effects and comprising a minor fraction of the total amount can be used, i.e., the composition consists essentially of the specified materials. Thus the invention where claimed with the open transition ‘comprises’ or variants thereof also includes embodiments which ‘consist of’ or ‘consist essentially of’ the recited combinations.

### EXAMPLES

The following Examples are merely illustrative and are not meant to limit any aspects of the present disclosure in any way.

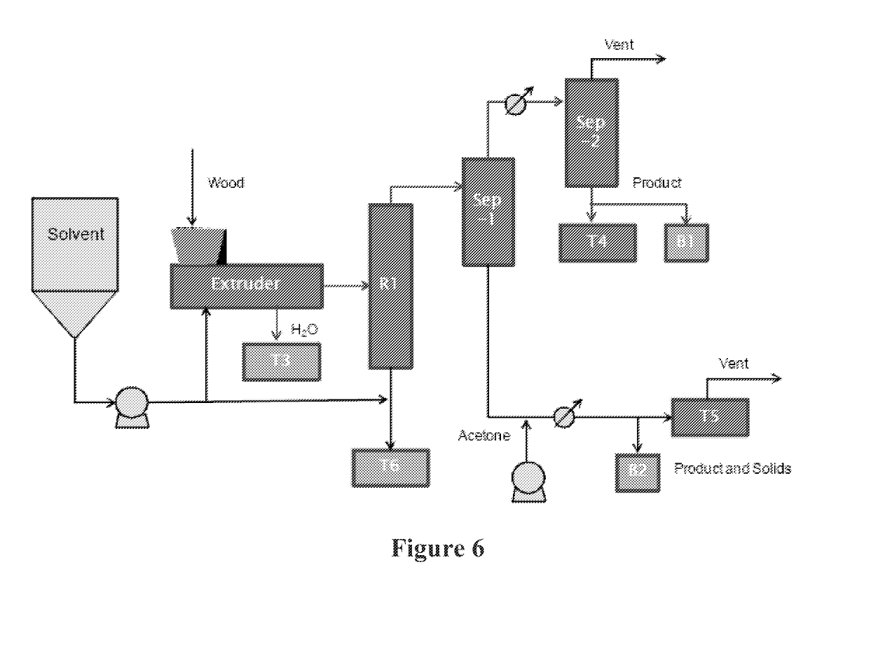

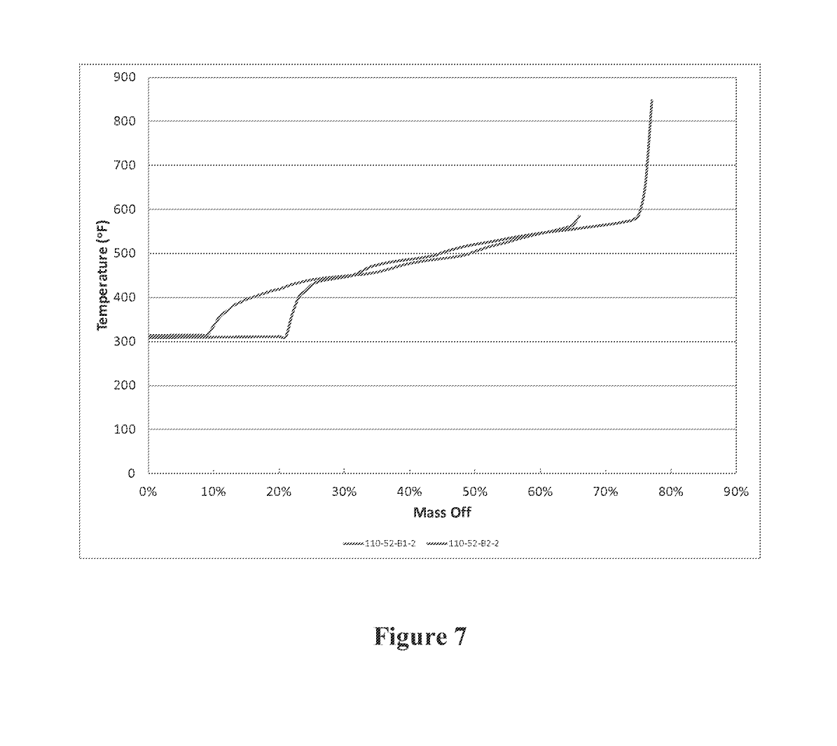

FIG. 6 shows a block diagram of a continuous flow system implementing the methods described herein. Fresh solvent and/or recycle bio-oil stream chosen for the solvent combination, which contains a liquefaction solvent and a make-up solvent, is provided, and is pumped into the reactor along with biomass. Biomass is fed into the pressurized reactor by an extruder. The mixture of biomass and solvent combination passes into the reactor, or the reaction zone in the case of a flow-through system, where it is exposed to the desired temperature and pressure as described herein for a suitable reaction time or residence time. The reactor or reaction zone can be heated by any suitable means. In the flow-through system shown in FIG. 6, the reactor would be a pipe-like conduit suitable for handling the desired operating pressure and temperature, and it would be sized to provide a desired residence time in the heated zone at a suitable flow rate.

The reactor can optionally have an outlet for vaporized material to be collected as an ‘upper’ fraction. It has an outlet for the liquefaction reaction mixture to pass on to a first separation subsystem, which can be a filtration apparatus, for example. Filtration separates insoluble solids from the crude liquid product that is then passed forward through the system as the solids are removed. Optionally, the system includes an inlet for a processing solvent such as acetone to be blended with the crude reaction product before filtration, and a recycle system to vaporize the acetone out of the crude liquid product after filtration, so that the acetone can be contained and re-used. The crude liquid product is then passed into a thermal separation subsystem, where it is fractionated into an upper volatile stream and a less volatile heavy wood oil product (bio-oil). The upper volatile fraction from the thermal separation of the crude liquid product can then be further separated and processed to provide a medium volatility bio-oil product. The thermal separation subsystem permits recovery of any volatile solvent components, and part of the separated product can be used as a recycle stream to provide a make-up solvent after partial hydrogenation, for example.

The heavy and medium bio-oil products can be further processed as described herein. Process gases from the reactor and/or the thermal separator can be captured for further use or separation. Solids, too, including char from the liquefaction reaction, can also be captured for further use or processing. The gas and solid by-products are in some systems used to generate heat to operate the system.

An example of a process operated in this system is described below. The process described below ran for a total of nine hours as a continuous flow process. For the first 30 minutes, the system was run cold (other than the drying section of the extruder) while the biomass feed was increased from 1.0 lbs/hr to 2.0 lbs/hr and the pressure was slowly increased to 600 psig. During the next 30 minutes, the extruder temperatures (heating the biomass before it enters the reaction container) and reaction container temperatures were raised to operating conditions, about 390° C. It took one hour more to reach steady-state conditions where flow rates were measured to assess the overall process.

The biomass feed for this example was loblolly pine from Philadelphia, Mississippi, which had been screened over a Black Clawson Gyratory screen Model 580 with ¼″ square perforations. The solvent was a mixture of 25% hydrotreated LCO (produced in Richmond at 1500 psig H₂ and cut at 575° F.) and 75% Aromatic 200 ND.

### Mass Balance

The overall measured mass balance for the run was 99.2%. It was determined by calculating the amount of feed to the unit, and by summing the total mass from the collected samples. Most of the numbers come directly from measurements taken during the mass balance, but gas and T6 have to be done differently. The gas measurement was calculated by averaging the flow rate for the hour previous to the mass balance, and using normalized MS data along with the flow rate (see Gas Production). The actual flow rate measured during the mass balance time period is highly inaccurate due to the large volume of empty space the sample vessels introduce to the system. T6 could only be recovered by rinsing the entire vessel with acetone and removing the acetone by rotovap. Thus the T6 number was not directly measured, but comes from the analytical workup. The masses used are listed in Table 3.

TABLE 1
Process parameters measured analytically before the run.

| Parameter | Value | Units |
|---|---|---|
| ρ solvent | 0.936 | g/mL |
| Feed Moisture | 60.7 | % |
| Ash Content | 0.510 | % |

TABLE 2
Process variables measured during the run.

| Variable | Value | Units |
|---|---|---|
| P1 | 10.0 | mL/min |
| P2 | 20.1 | mL/min |
| P3 | 5.00 | mL/min |
| P4 | 24.7 | mL/min |
| Feed Rate | 2.00 | lbs/hr |

TABLE 3
Overall mass balance.

| Expected Mass In | (g) | Collected Mass Out | (g) |
|---|---|---|---|
| Feed | 1813 | B1 | 711 |
| Bone Dry | 712 | B2 | 6284 |
| H2O | 1101 | T3 | 773 |
| Solvent | 3930 | Sep-4 | 2 |
| Acetone | 2266 | Sep-5 | 6 |
| | | T6 (from analysis) | 35 |
| | | Gas | 134 |
| TOTAL | 8009 | TOTAL | 7945 |

Each collected sample was filtered through medium-porosity filter paper. The original filtrate is referred to by sample number. The residue was washed with acetone, and the acetone was removed by rotovap. The remaining liquid is distinguished by “(acetone).” Any remaining solids were labeled as “acetone insolubles.” The solids were dried overnight in a vacuum oven at 105° C. If a sample consisted of multiple phases (organic and H₂O), then the phases were separated by extraction. The masses of each fraction can be seen in Table 4.

Overall conversion was 97.3%, using an ash-free, moisture-free basis (AFMF). The conversion is significantly higher than other experiments run under similar reaction conditions. The difference is attributed to the addition of acetone immediately after Sep-1. There are two theories why the improvement occurs. The first explanation is that, since the acetone dissolves most of the bio-oil, the remaining solid is unable to “seed” further solid formation. The second explanation is that the acetone stabilizes the product, as well as further diluting it, so that the bio-oil is unlikely to react with itself and form heavier molecules.

A detailed elemental mass balance calculation was performed. The adjusted results calculated a bio-oil yield of 58.5% and an oxygen content of 29.4%. These numbers are significantly higher than those obtained in earlier runs without the acetone injection. It is to be expected, however, that a higher bio-oil yield would also have a higher oxygen content. This is due to less gas formation (decarboxylation) and less remaining solid, which usually has a high oxygen content.

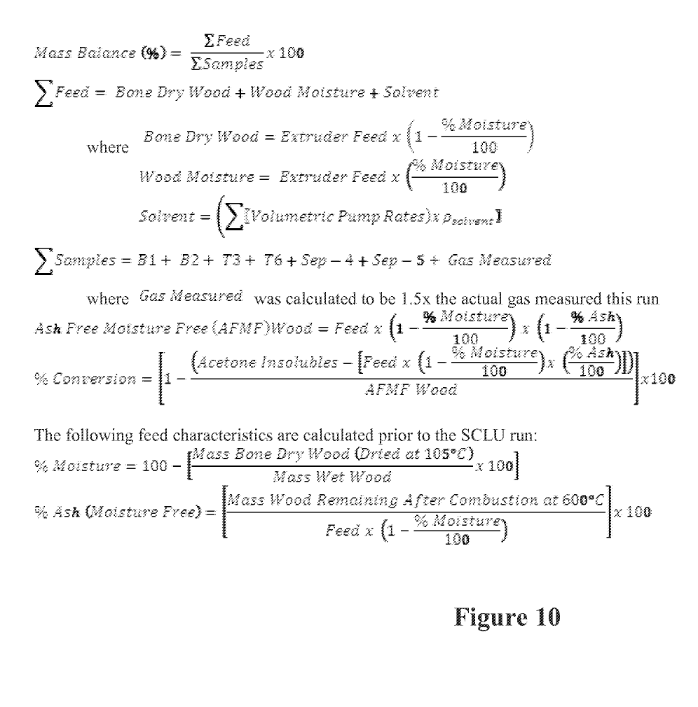

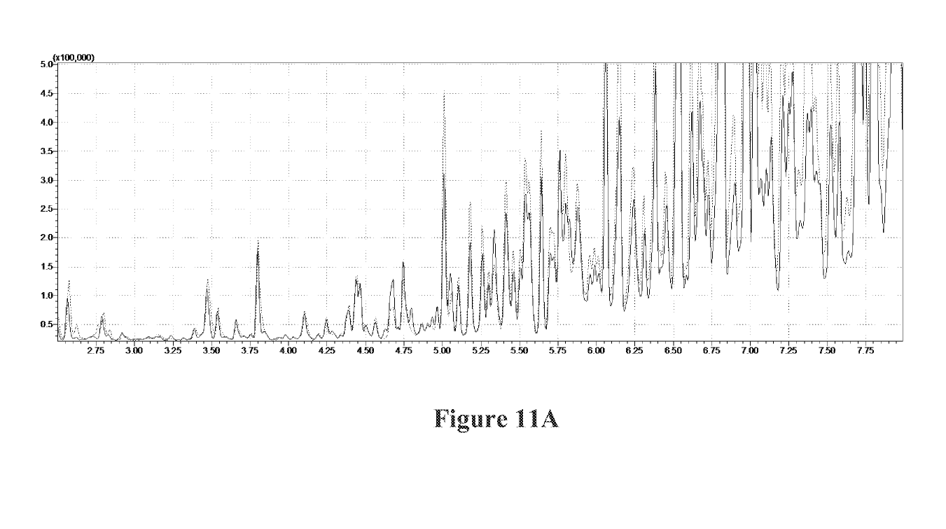

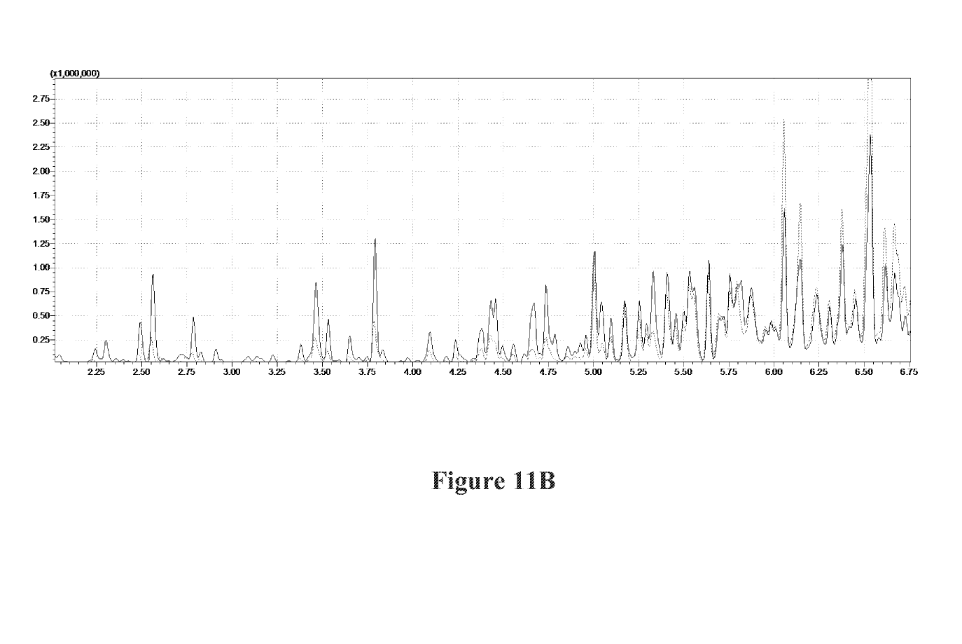

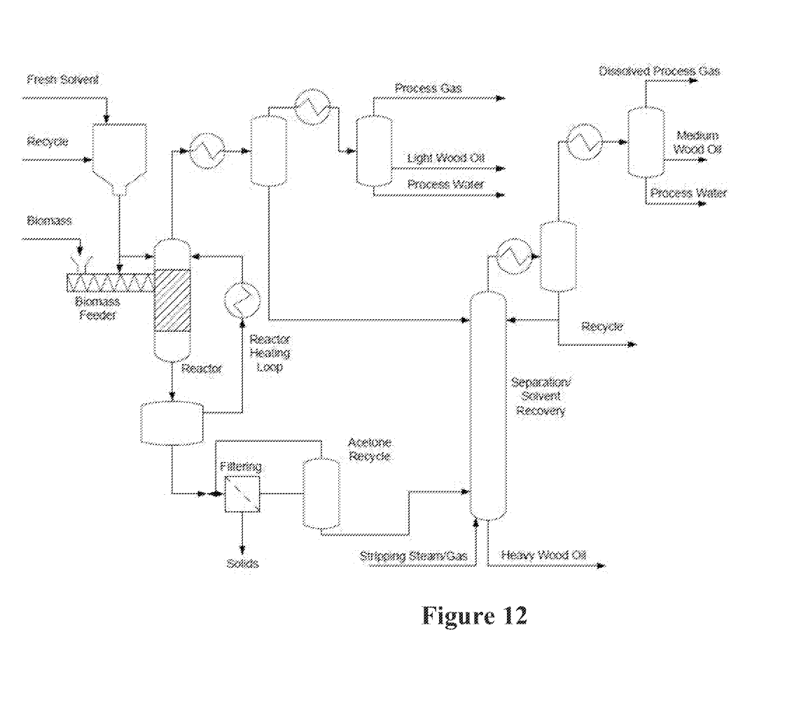

The equation used to determine conversion is shown in FIG. 10. Analytical methods used include SimDist, GCMS, chloride analysis, pH, CHN, density, TAN, Dean-Stark, and HPLC.

TABLE 4
Analytical mass balance.

| | (g) |
|---|---|
| Analytical Mass In | |
| TOTAL | 7890 |
| Analytical Mass Out | |
| Acetone Insolubles | 22.8 |
| T6 | 0.644 |
| B1 | 0.156 |
| B2 | 22.0 |
| Organic Liquid | 4885 |
| B1 | 334 |
| B2 | 4509 |
| T6 | 34.2 |
| Sep-4 | 1.71 |
| Sep-5 | 6.0 |
| H₂O | 1138 |
| T3 | 773 |
| B1 | 365 |
| Acetone | 1588 |
| TOTAL | 7633.8 |

The pH of the water phases can have important implications for the disposal of waste streams. The pH was measured in the lab for the two aqueous phases collected during the run. The results are shown below in Table 5.

TABLE 5
pH measurement of aqueous phases.

| Sample | pH |
|---|---|
| 110-52-T3-2 | 4.76 |
| 110-52-B1-2 H2O Phase | 2.93 |

CHN

The CHN analysis shown in Table 6 provides insight into product characteristics and behaviors. The starting solvent has no oxygen content, so products can be tracked (at a high level) by observing which streams become highly oxygenated. By that reasoning, Sep-4-1 and Sep-5-1 are nearly pure solvent. Light oxygenated products fractionate into the B1-1 HC stream (with some partitioning into the H₂O phase—see the HPLC section). The process stream with the most oxygen, however, is B2. Residual acetone in the stream accounts for some, but certainly not all, of this oxygen. The majority of our product is heavy material that is not soluble in the starting solvent.

TABLE 6
CHN data for mass balance samples. O is calculated by difference.

| | | | | O (by |
|---|---|---|---|---|
| | C | H | N | diff) |
| Starting Solvent (25% LCO/75% | 91.025 | 10.714 | 0.146 | −1.880 |
| HAN 200 ND) | | | | |
| 110-52-B1-2 HC | 88.015 | 10.963 | 0.259 | 0.76 |
| 110-52-B1-2 Acetone Wash | 84.312 | 10.790 | 0.433 | 4.47 |
| 110-52-B2-2 Rotovap | 83.467 | 10.400 | 0.061 | 6.07 |
| 110-52-B2-2 Acetone Insolubles | 83.439 | 5.844 | 0.302 | 10.42 |
| 110-52-Sep-4-2 | 90.229 | 10.877 | 0.309 | −1.41 |
| 110-52-Sep-5-2 | 90.390 | 10.842 | 0.354 | −1.59 |
| 110-52-T6-2 Acetone Wash | 82.412 | 10.555 | 0.267 | 6.77 |
| 110-52-T6-2 Acetone Insolubles | 50.304 | 7.135 | 0.364 | 42.20 |

Density

Density measurement is another way to distinguish different phases present in the process. Density was taken for the HC phase of B1, the B2 filtered liquid, the B2 rotovap liquid, and the T6 rotovap liquid. The results are shown in Table 7. The B1 liquid is significantly lighter than the B2 liquid or the T6 liquid. This is expected because any material in Sep-2 was a gas at ˜600° F. and 600 psi. The density of the B2 material did not change much from the starting material. Usually there is a slight density increase in the B2 liquid due to a) product formation and b) the light ends were removed by Sep-1. In this case, residual acetone in the B2 liquid has probably reduced the density a little.

TABLE 7
Density measurements for mass balance samples.

| Sample | API | Density (g/mL) |
|---|---|---|
| SCLU110-52-B1-2 | 22.9 | 0.9155 |
| HC Phase | | |
| SCLU110-52-B2-2 Rotovap Liquid | 17.2 | 0.9317 |
| SCLU110-52-T6-2 Acetone Wash | 22.4 | 0.9136 |

### TAN

The TAN number was measured to indicate the corrosive properties of the liquefaction products. The first result is from the standard ASME TAN test. The second number is from a modified test, where the titration continued until an endpoint pH of 10.0. The modified TAN was measured because the standard TAN does not account well for oxygenated compounds, including phenols.

As shown in Table 8, the modified TAN numbers are much higher than the standard TAN. These samples should contain high amounts of organic acids and phenols, so the numbers are expected. Metallurgical testing will need to be completed to determine the acceptable TAN limit for the product.

TABLE 8
TAN analysis of heavy product streams. The modified TAN
number is obtained by titrating to an endpoint of pH 10.0.

| | | Modified TAN |
|---|---|---|
| Sample | TAN (mg KOH/g) | (mg KOH/g) |
| 110-52-B2-1 | 3.08 | 4.580 |
| 110-52-B2-2 | 2.43 | 6.57 |

### Water Determination

After examining the analytical results shown in Table 4, it was obvious that not enough water was recovered during the workup. It is known from literature and bench-scale experiments that between 15 and 25% of the BD feedstock becomes H₂O during the liquefaction process. Dean-Stark analysis and Karl-Fisher titrations were run on several liquid phases to locate some of the “missing” water. The results are shown in below in Table 9. The results show that very little of the missing water is in the product streams. As mentioned in previous runs, it is likely the water disappeared through the vent line of T3 and that an additional small amount of water was probably lost in the vent line from Sep-2 due to the moisture saturation of the gas.

TABLE 9
Water determination results for liquid process samples.

| | H₂O | | | |
|---|---|---|---|---|
| | Determination | Amount | H₂O | |
| | Test | Tested (g) | Recovered (g) | % H₂O |
| B2-1 Filtered | Dean Stark | 9.0 | 0 | 0.00 |
| B2-2 | Dean Stark | 9.0 | 0 | 0.00 |
| B2-1 Filtered | Karl Fisher | | | 274 ppm |
| B2-2 | Karl Fisher | | | 0.16% |

### HPLC

HPLC analysis was completed on the water samples. The T3 sample was collected from the steam vent of the extruder. This water was mostly pure, containing only small amounts of sugar degradation products. The B1 water phase, however, had significant quantities of impurities. A quantitative list of impurities is shown in Table 10.

TABLE 10
Compounds identified in B1 water layer via HPLC.

| | Amount |
|---|---|
| Compound | (mg/mL) |
| Rhamnose | 0.031 |
| Glyceraldehyde | 0.005 |
| Glycolic Acid | 0.398 |
| L-Lactic Acid | 0.222 |
| Formic Acid | 0.092 |
| Acetic Acid | 33.3 |
| Glycerol | 4.57 |
| o-Cresol | 2.62 |
| 2-Methoxyethanol | 2.05 |
| Methanol | 20.2 |
| Ethanol | 7.36 |
| p-Cresol | 0.420 |
| Valeric Acid | 0.306 |
| HMF | 0.072 |
| 2-Butanol | 2.09 |
| Furfural | 0.462 |
| Phenol | 0.117 |
| TOTAL | 74.3 |

Most of the listed compounds are sugar degradation products, sugar hydrolysis products, and light phenolic products from lignin degradation. The amount of acids and phenols suggest that significant wastewater treatment will have to occur if this phase is sent to waste without undergoing further processing. The water removed by drying, however, is relatively clean.

Gas Production

Since O₂ and N₂ are not products of biomass liquefaction, it is assumed that these gasses are due to the presence of air or the N₂ used to startup the unit. The values of the other four gasses are normalized, and these are the values reported and using during mass balance calculations. Batch analysis has shown that other gases are present, including H₂ and C₃ through C₆ hydrocarbons. These are usually present in very low quantities, however, so they are excluded from the mass balance calculations (>7%).

For this run, the CH₄ tag was not working properly. CH₄ was calculated by subtracting the normalized CO₂, CO, and C₂H₆ values from 100. The results are shown in Table 11.

TABLE 11
MS data for gas production.

| Gas | Reported Values | Normalized Values |
|---|---|---|
| 2^{CO} | 23.8 | 49.9 |
| CO | 10.0 | 37.7 |
| 4^{CH} | 5.0 (calculated) | 10.4 |
| 6^{H}2^{C} | 0.6 | 1.9 |
| 2^{O} | 55.0 | |
| 2^{N} | 5.6 | |

This run provided significantly higher conversion and oxygen content than expected from earlier runs, or from the batch studies. It is possible that the acetone is playing a more important role than just keeping the heavy liquid in solution. There are plans to complete another run shortly (at the same conditions) to confirm the results.

Equipment

pH: Thermo Scientific Orion 4-star Benchtop pH meter

GCMS: Shimadzu QP 2010+, RTX-5MS column with Integra-Guard

HPLC, Sugars: Agilent 1200 Series, Bio-Rad Aminex HPX-87P column

HPLC, Byproducts: Agilent 1200 Series, Bio-Rad Aminex HPX-87H column

The overall calculated conversion of this run was 97.3% (on an ash-free, moisture-free basis). This is significantly better than the 91.2% conversion determined by a batch experiment; the batch experiment, however, had no acetone present during the reaction quench time.

The overall calculated mass balance was 99.6%. These results show that the wood oil yield was 58.5% and the wood oil has a 29.4% oxygen content. Both numbers are higher than those observed using the system without acetone.

In one pilot-scale run of the process as described herein, the following mass balances of products were observed:

TABLE 13

| | Mass, | | | | |
|---|---|---|---|---|---|
| | grams | Carbon | Hydrogen | Nitrogen | Oxygen |
| Wood in | 580 | 50% | 7% | 0% | 42% |
| wood oil, organic | 299 | 69% | 8% | 2% | 21% |
| phase | | | | | |
| water generated | 64 | 0% | 11% | 0% | 89% |
| gas phase | 168 | 34% | 3% | 0% | 63% |
| solid phase (char) | 48 | 74% | 5% | 0% | 21% |
| char yield | 8.4% | | | | |
| wood oil yield | 52% | | | | |
| Carbon yield (in | 71% | | | | |
| wood oil only) | | | | | |

The wood oil product fraction from this process can be upgraded to drop-in fuel by hydroprocessing to a high hydrogen-content, oxygen free product suitable as a drop-in fuel product. The process is a breakthrough as compared with processes that are known—traditional coal to liquid technology or biomass pyrolysis technology—for a number of reasons. Table 14 shows some of the key differences between our solvent liquefaction process and state of the art pyrolysis (Elliot, 2007) and coal liquefaction (Bellman, 2007). The primary attributes to note here are that solvent liquefaction can use a less processed feedstock, and requires far less hydrogen than fast pyrolysis. Since it operates at far lower pressures and shorter residence times than direct coal liquefaction, the reactor is technically simpler and more economic.

TABLE 14
Comparison of the solvent liquefaction process to fast pyrolysis
and coal liquefaction methods known in the art.

| | | | Direct Coal |
|---|---|---|---|
| | Solvent Liquefaction | Fast Pyrolysis | Liquefaction |
| Feedstock moisture | 10-35% moisture | <10% moisture | <10% moisture |
| requirements | | | |
| Feedstock size | Any size up to 1″ length | <1/4″ characteristic | Pulverized |
| requirements | chips* | dimension | (bituminous coal) |
| Reactor pressure | 250 to 600 psig | atmospheric | 3000 psig |
| Reactor temperature | 400 C. | 500-600 C. | 450 C. |
| Reactor time | 10 minutes | 3-10 seconds | Several hours |
| Before hydrotreating | ~20% | ~36% | 0—(but start with |
| O₂ content of bio-oil | | | low oxygen) |
| Hydrogen added for | 4000 scf/barrel product | 5500-7000 scf/barrel | 4000-7000 |
| process and to make | | product | |
| drop in fuel | | | |
| Yield per ton feedstock | 100-120.gal/ton after | 80-110 gal/ton after | 100-120 gal/ton |
| dry | hydrotreating | hydrotreating | |

*The SCLU pilot unit uses a feeding system that requires sawdust-sized particles; improved feed systems are in development for production scale processing.

We claim:

1. A process for liquefaction of biomass comprising:
(a) combining biomass with a solvent combination comprising at least one liquefaction solvent having a Hansen radius of interaction with coniferyl alcohol of less than 15 MPa^{1/2} and at least one make-up solvent to form a liquefaction mixture, and
(b) heating the liquefaction mixture to a temperature of at least about 250° C. under pressure of at least 200 psi, without adding H₂, to produce a reaction product comprising a liquid crude bio-oil product.

2. The process of claim 1, further comprising carrying out step (b) without adding carbon monoxide.

3. The process of claim 1, wherein a carbon monoxide by-product of the liquefaction process is recycled into the liquefaction mixture.

4. The process of claim 3, wherein the biomass is selected from the group consisting of lignin, cellulose, and combinations thereof.

5. The process of claim 4, wherein the solvent combination comprises a phenol or an anisole.

6. The process of claim 5, wherein the solvent combination comprises sinapyl alcohol, p-coumaryl alcohol, phenol, 2,6-dimethoxyphenol, 3,5-dimethyl phenol, 2,4-dimethyl phenol, anisole, 2-methyl anisole, 3-methyl anisole, 4-methyl anisole, guaiacol, m-cresol, o-cresol, p-cresol, phenoxypropanol, 1-butanol, tetrahydrofuran, naphthalene, acetone, 1-methylnaphthalene, tetralin, or a green crude or a fraction thereof.

7. The process of claim 6, wherein the liquefaction solvent has a Hansen radius of interaction with coniferyl alcohol less than about 14 MPa^{1/2}.

8. The process of claim 7, wherein the mixture is heated in the pressurized container to a temperature between about 300° C. and 600° C. for a period of time up to about 120 minutes.

9. The process of claim 8, wherein the pressure in the pressurized container is between about 200 psi and about 1500 psi while the mixture is being heated.

10. The process of claim 9, wherein the pressurized container is heated to a temperature between about 350° C. and 420° C. to promote liquefaction, while the pressure is between about 200 psi and about 800 psi.

11. The process of claim 10, wherein the solvent combination comprises up to about 25% hydrogen donor solvent.

12. The process of claim 11, wherein the make-up solvent comprises a refinery stream produced from a petroleum input.

13. The process of claim 12, wherein the liquefaction solvent comprises one or more phenolic compounds, aromatic alcohols, or anisoles.

14. The process of claim 13, wherein the amount of make-up solvent used is between 5% and 25% of the amount of biomass on a dry weight basis.

15. The process of claim 14, wherein the make-up solvent is converted into a make-up solvent product under the liquefaction conditions,
and wherein the make-up solvent product is suitable for hydroprocessing with the bio-oil product derived from the biomass liquefaction, and wherein the bio-oil product can be combined with a refinery stream for co-processing to provide a transportation fuel.

16. The process of claim 15, wherein the refinery stream is a light cycle oil having a boiling range below about 343° C.

17. The process of claim 1, wherein a portion of the crude reaction product is diverted to form a solvent recycle stream, which is used as part of the solvent combination for use in the process of claim 1.

18. The process of claim 17, wherein the portion of the crude reaction product that is recycled has a boiling range between about 180° C. and 343° C.

19. The process of claim 18, wherein a metal reagent is added to enhance liquefaction.

20. The process of claim 19, wherein the metal reagent is one or more metals, wherein the one or more metals are selected from the group consisting of Group VIII metals, Group IB metals, Group IIB metals, Group IIIA metals, Group IVA metals, and a combination thereof.

21. The process of claim 18, wherein a metal catalyst is added to enhance liquefaction.

22. The process of claim 21, wherein the metal catalyst is one or more metals, wherein the one or more metals are selected from the group consisting of Group VIII metals, Group IB metals, Group IIB metals, Group IIIA metals, Group IVA metals, and a combination thereof.

23. The process of claim 21, wherein the metal catalyst is a zeolite or a molybdenum salt.

24. The process of claim 23, wherein the biomass contains at least about 10% lignin by weight.

25. The process of claim 24, further comprising adding a processing solvent to the liquefaction mixture or to the crude liquefaction reaction product.

26. The process of claim 25, wherein the processing solvent is a C3-C6 ketone solvent and is added after completion of the liquefaction reaction.

27. The process of claim 26, which is operated as a continuous flow process, wherein the solvent mixture and biomass pass through a reaction container configured for flow-through operation, where they are heated under pressure for a sufficient time to promote liquefaction.

28. The process of claim 27, wherein the biomass has a moisture content of at least about 15%.

29. The process of claim 28, further comprising an additional step of hydroprocessing the bio-oil product and/or feeding the bio-oil product to a catalytic cracker.

30. A system for liquefaction of biomass, comprising:
a reaction container suitable for conducting a biomass liquefaction process at a temperature above about 300° C. and a pressure above about 300 psi;
wherein the reaction container contains:
a solvent combination comprising a make-up solvent, and at least one liquefaction solvent having a Hansen radius of interaction with coniferyl alcohol of less than 15 MPa^{1/2},
and biomass comprising lignin and/or cellulose.

31. The system of claim 30, wherein the mass of the solvent combination in the reaction container is about 50% or more of the mass of biomass in the reaction container.

32. The system of claim 30 or 31, wherein the reaction container is a flow-through container and the system is configured to provide a continuous flow process for the process of any of claims 1-29.

33. The system of claim 32, further comprising a recycle subsystem which is configured to separate a portion of the crude product from the reaction container to form a recycle solvent stream, and to deliver the recycle solvent stream to the reaction container.

34. The system of claim 33, wherein the mass of the make-up solvent comprises about 25% or less of the mass of the biomass in the reaction container when the reaction container is ready for operation.

35. The system of claim 34, wherein the solvent combination comprises a light cycle oil from a refinery.

36. The system of claim 35, wherein the reaction container further contains a metal reagent.

37. The system of claim 36, wherein the metal reagent is one or more metals, wherein the one or more metals are selected from the group consisting of Group VIII metals, Group IB metals, Group IIB metals, Group IIIA metals, Group IVA metals, and a combination thereof.

38. The system of claim 37, wherein the reaction container further contains a metal catalyst.

39. The system of claim 38, wherein the metal catalyst is one or more metals, wherein the one or more metals are selected from the group consisting of Group VIII metals, Group IB metals, Group IIB metals, Group IIIA metals, Group IVA metals, and a combination thereof.

40. The system of claim 38, wherein the metal catalyst is a zeolite or a molybdenum salt.

41. The system of claim 40, further comprising one or more subsystems for feeding biomass and/or solvents into the reaction container.

42. The system of claim 41, further comprising a filtration system to remove residual solids from the crude reaction product or bio-oil produced in the reaction container.

43. The system of claim 42, further comprising a heater that is fueled at least in part by gases produced in the liquefaction reaction and/or by residual solids captured by the filtration system, and which is configured to heat the reaction container.

44. A composition comprising:
biomass,
a recycle stream from a biomass liquefaction reaction,
and a make-up solvent.

45. The composition of claim 44, wherein the make-up solvent comprises a refinery light cycle oil.

46. The composition of claim 44 or 45, wherein the recycle stream comprises solvents having a Hansen radius of interaction with coniferyl alcohol less than about 14 MPa^{1/2}.

47. The composition of claim 46, wherein the biomass comprises cellulose and lignin.
